(19) United States
(12) Patent Application Publication
(10) Pub. No.: US 2023/0416579 A1
(43) Pub. Date: Dec. 28, 2023

(54) AEROSOL RAW MATERIAL COMPOSITION, AEROSOL COMPOSITION, AND AEROSOL PRODUCT

(71) Applicant: AGC INC., Tokyo (JP)

(72) Inventors: Hiroki HAYAMIZU, Chiyoda-ku (JP); Hiroaki MITSUOKA, Chiyoda-ku (JP)

(73) Assignee: AGC INC., Tokyo (JP)

(21) Appl. No.: 18/462,641

(22) Filed: Sep. 7, 2023

Related U.S. Application Data
(63) Continuation of application No. PCT/JP2022/010080, filed on Mar. 8, 2022.

(30) Foreign Application Priority Data
Mar. 11, 2021 (JP) 2021-039454

(51) Int. Cl. C09K 3/30

(52) U.S. Cl. CPC C09K 3/30

(57) ABSTRACT

Provided is an aerosol raw material composition containing water and 1-chloro-2,3,3,3-tetrafluoropropene, in which a content of water is 1.0% by mass or more with respect to a total amount of water and 1-chloro-2,3,3,3-tetrafluoropropene.

### CROSS-REFERENCE TO RELATED APPLICATIONS

This application is a Continuation Application of International Application No. PCT/JP2022/010080, filed Mar. 8, 2022, the disclosure of which is incorporated herein by reference in its entirety. Further, this application claims priority from Japanese Patent Application No. 2021-039454, filed Mar. 11, 2021, the disclosure of which is incorporated herein by reference in its entirety.

### TECHNICAL FIELD

The present invention relates to an aerosol raw material composition, an aerosol composition, and an aerosol product.

### BACKGROUND ART

Foamy aerosol compositions are known which are stored in a container such as a spray can and form a foam after being discharged therefrom. In addition, freezing-type aerosol compositions which freeze after being discharged, and cooling-type aerosol compositions which exert a cooling effect after being discharged are known.

In these aerosol compositions, a stock solution and a flammable liquefied gas serving as a propellant are used, and these aerosol compositions require careful management and handling since they are flammable in the storage, consumption, and disposal processes of an aerosol product in which each aerosol composition is enclosed in a container such as a spray can. Particularly, in the container disposal process after the use of all of the product contents, a container disposed with a liquefied gas remaining therein occasionally causes an explosion and fire accident.

In order to reduce such a risk, an aerosol composition which contains a stock solution, an aliphatic hydrocarbon, and a non-flammable compressed gas instead of a flammable liquefied gas has been proposed (Japanese Patent Application Laid-Open (JP-A) No. H7-207256).

However, aliphatic hydrocarbons are highly flammable and thus, even a small discharge amount thereof puts the space of discharge destination into a combustion range, posing a risk of causing an explosion accident.

Accordingly, there has been proposed an aerosol composition in which a hydrofluoroolefin having a low global warming potential and a low ozone depletion potential along with a high halogen atom ratio in its structure is used in place of an aliphatic hydrocarbon (JP-A No. 2020-23474). Hereinafter, a hydrofluoroolefin is also referred to as

### SUMMARY OF THE INVENTION

### Technical Problem

Nevertheless, HFOs, which have a high halogen atom ratio in their molecules and contain a larger number of fluorine atoms than hydrogen atoms, tend to be highly flammable in an environment having a high moisture content in the air (Risk Assessment of Mildly Flammable Refrigerants, Final Report, March 2016, Japan Society of Refrigerating and Air Conditioning Engineers). Therefore, it is demanded to improve the flammability in the use of an HFO as a propellant of an aerosol composition.

An object of one embodiment of the invention is to provide an aerosol raw material composition, an aerosol composition, and an aerosol product, in which a propellant has a low flammability when discharged from a container such as a spray can.

### Solution to Problem

The present disclosure encompasses the following aspects.
[1] An aerosol raw material composition, containing: water; and 1-chloro-2,3,3,3-tetrafluoropropene,
wherein a content of water is 1.0% by mass or more with respect to a total amount of water and 1-chloro-2,3,3,3-tetrafluoropropene.
[2] The aerosol raw material composition according to [1], wherein a content of water is 5.0% by mass or more with respect to the total amount of water and 1-chloro-2,3,3,3-tetrafluoropropene.
[3] The aerosol raw material composition according to [1] or [2], wherein the total amount of water and 1-chloro-2,3,3,3-tetrafluoropropene is 50.0% by mass or more with respect to a total amount of the aerosol raw material composition.
[4] The aerosol raw material composition according to any one of [1] to [3], wherein a sprayed content in a flame generation condition test has a flame length of less than 4.0 cm, the flame generation condition test comprising:
as a spray container, one which includes a container body, a valve mechanism having a stem orifice diameter of 0.45 mm, a discharge member having a discharge orifice diameter of 0.6 mm, and a spray tube having an inner diameter of 1.0 mm is used; an aerosol product is prepared by filling an aerosol composition formed of the aerosol raw material composition and nitrogen into the spray container such that a pressure inside the spray container is 0.6 MPa at 25° C.; using the thus prepared aerosol product as a sample, a flame generation condition test is conducted in accordance with the procedure prescribed in JIS S3301(2018) 6.5, except that a spray nozzle of the sample is positioned 5 cm away from a flame burner; and a difference between a horizontal length of a flame with spraying of the content of the sample and the horizontal length of a flame without the spraying is defined as the flame length of the sprayed content.
[5] The aerosol raw material composition according to any one of [1] to [4], further containing a surfactant.
[6] The aerosol raw material composition according to any one of [1] to [5], further containing an alcohol.
[7] An aerosol composition, containing:
the aerosol raw material composition according to any one of [1] to [6]; and
at least one of a compressed gas or a liquefied gas.
[8] The aerosol composition according to [7], containing, as the compressed gas, at least one selected from the group consisting of nitrogen, air, oxygen, hydrogen, carbon dioxide, and nitrous oxide.
[9] The aerosol composition according to [7], containing, as the compressed gas, at least one selected from the group consisting of nitrogen and carbon dioxide.
[10] The aerosol composition according to any one of [7] to [9], containing, as the liquefied gas, at least one selected from the group consisting of a liquefied petroleum gas, dimethyl ether, and a hydrofluoroolefin.
[11] The aerosol composition according to according to any one of [7] to [10], wherein a sprayed content in flame generation condition test has a flame length of less than 4.0 cm, the flame generation condition test comprising:

as a spray container, one which includes a container body, a valve mechanism having a stem orifice diameter of 0.45 mm, a discharge member having a discharge orifice diameter of 0.6 mm, and a spray tube having an inner diameter of 1.0 mm is used; an aerosol product is prepared by filling the aerosol composition into the spray container such that a pressure inside the spray container is 0.6 MPa at 25° C.; using the thus prepared aerosol product as a sample, a flame generation condition test is conducted in accordance with the procedure prescribed in JIS S3301(2018) 6.5, except that a spray nozzle of the sample is positioned 5 cm away from a flame burner; and a difference between a horizontal length of a flame with spraying of the content of the sample and the horizontal length of a flame without the spraying is defined as the flame length of the sprayed content.
[12] An aerosol product, including:
a container body; and
the aerosol composition according to any one of [7] to [11], which is stored inside the container body.
[13] The aerosol product according to [12], further including a valve mechanism attached to the container body.
[14] The aerosol product according to or [13], wherein a pressure inside the container body is 0.2 MPa or higher at 25° C.
[15] The aerosol product according to any one of to [14], wherein a sprayed content in a flame generation condition test has a flame length of less than 4.0 cm, the flame generation condition test comprising:
using the aerosol product as a sample, a flame generation condition test is conducted in accordance with the procedure prescribed in JIS S3301(2018) 6.5, except that a spray nozzle of the sample is positioned 5 cm away from a flame burner; and a difference between a horizontal length of a flame with spraying of the content of the sample and the horizontal length of a flame without the spraying is defined as the flame length of the sprayed content.

### Advantageous Effects of Invention

According to one embodiment of the invention, the following can be provided: an aerosol raw material composition, an aerosol composition, and an aerosol product, in which a propellant has a low flammability when discharged from a container such as a spray can.

### DESCRIPTION OF EMBODIMENTS Terms used in the disclosure have the following meanings.

Those numerical ranges that are expressed with “to” each denote a range that includes the numerical values stated before and after “to” as the lower limit value and the upper limit value, respectively.

In the present specification, with regard to a halogenated hydrocarbon, an abbreviation of its compound is stated in parentheses after the compound name and, if necessary, the abbreviation may be used in place of the compound name. Further, as the abbreviation, only a part consisting of numerals and lower-case alphabets after a hyphen (-) may be used. For example, “1224yd” may be used for “HCFO-1224yd”.

In the present specification, when a name or abbreviation of a compound is used without any specific description, the name or abbreviation represents at least one selected from Z-form or E-form, more specifically Z-form or E-form, or a mixture of Z-form and E-form at an arbitrary ratio. A name or abbreviation of a compound followed by (E) or (Z) represents E-form or Z-form of the compound. For example, “1224yd(Z)” represents Z-form, and “1224yd(E)” represents E-form.

Modes for carrying out the invention will now be described.

### <<Aerosol Raw Material Composition>>

The aerosol raw material composition of the disclosure contains water and 1-chloro-2,3,3,3-tetrafluoropropene (CF3-CF=CHC1, HCFO-1224yd).

(Water)

Water is used as a solvent. This water is not particularly limited. Examples of the water include purified water, ion exchanged water, physiological saline, and deep sea water.

The content of water is not less than 1.0% by mass with respect to a total amount of water and 1224yd. The content of water is preferably not less than 2.0% by mass, more preferably not less than 3.0% by mass, still more preferably not less than 4.0% by mass, particularly preferably not less than 5.0% by mass, with respect to a total amount of water and 1224yd. An upper limit of the content of water is not particularly limited, and it is often 99% by mass or less with respect to a total amount of water and 1224yd. A preferred range of the content of water varies depending on the intended use of an aerosol composition containing the aerosol raw material composition. Therefore, a preferred range of the content of water will be described below for each use of the aerosol composition.

(1224yd)

As 1224yd, (Z)-1-chloro-2,3,3,3-tetrafluoropropene (1224yd(Z)) or (E)-1-chloro-2,3,3,3-tetrafluoropropene (1224yd(E)) may be used singly, or 1224yd may be a mixture of 1224yd(Z) and 1224yd(E). From the standpoint of making it easier to obtain an aerosol composition having excellent post-foaming properties or an aerosol composition having excellent cooling properties, the aerosol raw material composition preferably contains 1224yd that is substantially 1224yd(Z) alone. By incorporating 1224yd that is substantially 1224yd(Z) alone, the resulting aerosol composition has excellent post-foaming properties or cooling properties. This is believed to be because the boiling point of 1224yd(Z) is lower than that of 1224yd(E). The phrase “substantially 1224yd(Z) alone” used herein means that the content of 1224yd(Z) is 99% by mass or more with respect to a total amount of 1224yd(Z) and 1224yd(E).

In the aerosol raw material composition, a molar ratio of the content of 1224yd(E) and the content of 1224yd(Z) (molar amount of 1224yd(E)/molar amount of 1224yd(Z)) may be from 0/100 to 100/0. From the standpoint of the post-foaming properties and the cooling properties, the molar ratio of the content of 1224yd(E) and the content of 1224yd(Z) (molar amount of 1224yd(E)/molar amount of 1224yd(Z)) is preferably from 0/100 to 10/90, more preferably from 0/100 to 5/95, still more preferably from 0/100 to 1/99.

A preferred range of the content of 1224yd varies depending on the intended use of an aerosol composition containing the aerosol raw material composition. Therefore, a preferred range of the content of 1224yd will be described below for each use of the aerosol composition.

As shown in the below-described Examples, the aerosol raw material composition of the disclosure that contains water and 1224yd is non-flammable even in an environment having a high moisture content in the air. Accordingly, the aerosol raw material composition has a low flammability when discharged from a container such as a spray can.

The aerosol raw material composition of the disclosure may also contain the below-described components in addition to water and 1224yd, depending on the intended use of an aerosol composition containing the aerosol raw material composition.

(Surfactant)

When an aerosol composition containing the aerosol raw material composition of the disclosure is used as a foamy aerosol composition that forms a foam after being discharged, a surfactant is preferably incorporated as an emulsifier that emulsifies 1224yd with an aqueous component of the aerosol raw material composition. The “aqueous component” of the aerosol raw material composition refers to, among the components of the aerosol raw material composition, those components that exclude 1224yd.

Further, the surfactant is preferably incorporated for the purposes of, for example, forming a foam by, when discharged to the outside, causing a compressed gas dissolved in the aerosol composition to become fine bubbles and be dispersed, facilitating vaporization of 1224yd, which is emulsified in the aerosol raw material composition, through the generation of bubbles, and thereby allowing the aerosol raw material composition to foam.

The surfactant is not particularly limited. Examples of the surfactant include:
anionic surfactants, for example, saponification products of a fatty acid such as myristic acid or stearic acid, and an alkali such as triethanolamine or potassium; lauryl phosphoric acid, and alkyl phosphates such as potassium lauryl phosphate and sodium lauryl phosphate; polyoxyethylene alkyl ether phosphates, such as sodium POE (polyoxyethylene) lauryl ether phosphate; alkyl sulfates, such as ammonium lauryl sulfate, potassium lauryl sulfate, sodium lauryl sulfate, triethanolamine lauryl sulfate, and sodium cetyl phosphate; polyoxyethylene alkyl ether sulfates, such as sodium POE lauryl ether sulfate, triethanolamine POE lauryl ether sulfate, sodium POE alkyl ether sulfate, and triethanolamine POE alkyl ether sulfate; alkyl ether carboxylates, such as potassium POE lauryl ether acetate, sodium POE lauryl ether acetate, potassium POE tridecyl ether acetate, and sodium POE tridecyl ether acetate; and sulfonates, such as sodium lauryl sulfoacetate, sodium tetradecene sulfonate, sodium dioctyl sulfosuccinate, sodium dialkyl sulfosuccinate, sodium alkyl naphthalene sulfonate, sodium alkyl diphenyl ether disulfonate, sodium alkane sulfonate, dodecylbenzene sulfonic acid, and sodium dodecylbenzene sulfonate;
amino acid-based anionic surfactants, for example, N-acyl glutamates such as triethanolamine N-coconut oil fatty acid acyl-L-glutamate, potassium N-coconut oil fatty acid acyl-L-glutamate, sodium N-coconut oil fatty acid acyl-L-glutamate, triethanolamine N-lauroyl-L-glutamate, potassium N-lauroyl-L-glutamate, sodium N-lauroyl-L-glutamate, potassium N-myristoyl-L-glutamate, sodium N-myristoyl-L-glutamate, and sodium N-stearoyl-L-glutamate; N-acyl glycine salts, such as potassium N-coconut oil fatty acid acyl glycine and sodium N-coconut oil fatty acid acyl glycine; N-acyl alanine salts, such as triethanolamine N-coconut oil fatty acid acyl-DL-alanine; and acyl alanine salts, such as sodium lauroyl methyl alanine;
nonionic surfactants, for example, polyoxyethylene alkyl ethers, such as POE lauryl ether, POE cetyl ether, POE stearyl ether, POE oleyl ether, POE behenyl ether, and POE octyl dodecyl ether; polyoxyethylene polyoxypropylene alkyl ethers, such as POE-POP (polyoxypropylene) cetyl ether and POE-POP decyl tetradecyl ether; fatty acid alkanolamides, such as coconut oil fatty acid diethanolamide, coconut oil fatty acid monoethanolamide, lauric acid diethanolamide, and lauric acid monoisopropanolamide; polyethylene glycol fatty acid esters, such as polyethylene glycol monostearate; polyoxyethylene hardened castor oils; polyoxyethylene glycerin fatty acid esters, such as POE glyceryl monostearate and POE glyceryl monooleate; polyoxyethylene alkyl ether fatty acid esters, such as POE cetyl ether stearate and POE lauryl ether isostearate; polyoxyethylene sorbitan fatty acid esters, such as POE sorbitan monococonut oil fatty acid, POE sorbitan monostearate, POE sorbitan monooleate, and POE sorbitan triisostearate; and polyglycerin fatty acid esters, such as hexaglyceryl monolaurate, hexaglyceryl monomyristate, pentaglyceryl monolaurate, pentaglyceryl monomyristate, pentaglyceryl monooleate, pentaglyceryl monostearate, decaglyceryl monolaurate, decaglyceryl monomyristate, decaglyceryl monostearate, decaglyceryl monoisostearate, decaglyceryl monooleate, and decaglyceryl monolinoleate; and
amphoteric surfactants, for example, silicone-based surfactants, such as polyoxyethylene-methylpolysiloxane copolymers, polyoxypropylene-methylpolysiloxane copolymers, and poly(oxyethylene-oxypropylene)-methylpolysiloxane copolymers; betaine-type surfactants, for example, alkyl betaines such as lauryl dimethylamino acetic acid betaine (lauryl betaine), stearyl betaine, lauric acid amide propyl betaine, lauryl hydroxysulfobetaine, stearyl dimethylamino acetic acid betaine, dodecyl aminomethyl dimethyl sulfopropyl betaine, and octadecyl aminomethyl dimethyl sulfopropyl betaine, and fatty acid amide propyl betaines such as coconut acid amide propyl betaine, coconut oil fatty acid amide propyl dimethylamino acetic acid betaine (cocamidopropyl betaine), and cocamidopropyl hydroxysultaine; alkylimidazole-type surfactants, such as 2-alkyl-N-carboxymethyl-N-hydroxyethyl imidazolinium betaine; amino acid-type surfactants, such as sodium lauroyl glutamate, potassium lauroyl glutamate, and lauroyl methyl-β-alanine; and amine oxide-type surfactants, such as lauryl dimethylamine N-oxide and oleyl dimethylamine N-oxide.

A combination of these surfactants may be used.

Thereamong, as the surfactant, anionic surfactants, amino acid-based anionic surfactants, and nonionic surfactants are preferred since these surfactants readily emulsify 1224yd, improve the foamability of the resulting aerosol composition, and are capable of forming a foam having a fine texture and a stable shape.

A preferred range of the content of the surfactant varies depending on the intended use of an aerosol composition containing the aerosol raw material composition. Therefore, a preferred range of the content of the surfactant will be described below for each use of the aerosol composition.

(Alcohol)

When an aerosol composition containing the aerosol raw material composition of the disclosure is used as a cooling-type aerosol composition that exerts a cooling effect after being discharged, an alcohol is preferably incorporated for the purposes of, for example, allowing the aerosol raw material composition to have a homogeneous composition.

The alcohol is not particularly limited. Examples of the alcohol include: monohydric alcohols having from 2 to 3 carbon atoms, such as ethanol and isopropanol; polyhydric alcohols, such as propylene glycol, 1,3-butylene glycol, hexylene glycol, glycerol, dipropylene glycol, and diglycerol.

A preferred range of the content of the alcohol varies depending on the intended use of an aerosol composition containing the aerosol raw material composition. Therefore, a preferred range of the content of the alcohol will be described below for each use of the aerosol composition.

(Other Components)

The aerosol raw material composition of the disclosure may also contain, for example, an active ingredient, a monosaccharide, a water-soluble polymer, an oil agent, an oil-based solvent, a powder, and a preservative, depending on the intended use of an aerosol composition containing the aerosol raw material composition. These components will be described below.

A method of preparing the aerosol raw material composition is not particularly limited. The aerosol raw material composition can be prepared by any conventionally known method. For example, the aerosol raw material composition can be prepared by adding optional components, such as a surfactant, an alcohol, and other components, to water or heated water as required to prepare an aqueous component, and subsequently adding 1224yd to the aqueous component.

A total amount of water and 1224yd is modified as appropriate in accordance with the intended use of the aerosol composition; however, it is, for example, preferably not less than 10.0% by mass, more preferably not less than 30.0% by mass, still more preferably not less than 40.0% by mass, particularly preferably not less than 50.0% by mass, with respect to a total amount of the aerosol raw material composition. The total amount of water and 1224yd is also preferably 99.5% by mass or less, more preferably 99.0% by mass or less, still more preferably 95.0% by mass or less, particularly preferably 90.0% by mass or less, with respect to a total amount of the aerosol raw material composition.

When the aerosol raw material composition of the disclosure is subjected to the below-described flame generation condition test in which a measurement aerosol product 1 produced by the below-described method is used as a sample, a sprayed content has a flame length of preferably less than 4.0 cm, more preferably 3.5 cm or less, still more preferably 3.0 cm or less, yet still more preferably 2.5 cm or less, further preferably 2.0 cm or less, still further preferably 1.5 cm or less, further more preferably 1.0 cm or less, still further more preferably 0.5 cm or less, particularly preferably 0 cm.
Production of Measurement Aerosol Product 1

As a spray container, a tin spray container which includes a container body, a valve mechanism having a stem orifice diameter of 0.45 mm, a discharge member having a discharge orifice diameter of 0.6 mm, and a spray tube having an inner diameter of 1.0 mm is used. It is noted here that the inside of the container body has a cylindrical shape of 53 mm in inner diameter and 118 mm in height.

After filling 170 g of the aerosol raw material composition into the container body through an opening of the tin spray container, nitrogen is further filled as a compressed gas, and the pressure inside the container body is adjusted to be 0.6 MPa at 25° C., whereby the measurement aerosol product 1 is produced.

<<Aerosol Composition>>

The aerosol composition of the disclosure contains the aerosol raw material composition of the disclosure, and at least one of a compressed gas or a liquefied gas.

(Compressed Gas)

A compressed gas is preferably incorporated as a propellant that pressurizes and discharges the aerosol raw material composition to the outside. When the aerosol composition is used as a foamy aerosol composition that forms a foam after being discharged, the compressed gas is partially dissolved in the aerosol raw material composition, and this causes the dissolved compressed gas to become fine bubbles after discharge of the aerosol raw material composition to the outside, and to act as a foaming agent that facilitates vaporization of 1224yd and forms a foam by allowing the aerosol raw material composition to foam.

The compressed gas is not particularly limited. Examples of the compressed gas include nitrogen, air, oxygen, hydrogen, carbon dioxide, and nitrous oxide. The compressed gas preferably contains at least one selected from the group consisting of nitrogen and carbon dioxide.

(Liquefied Gas)

When the aerosol composition is used as a freezing-type aerosol composition that freezes after being discharged, a liquefied gas, which is a liquid having a vapor pressure in a container body and is vaporized when sprayed, is preferably incorporated for the purposes of, for example, cooling and freezing an aqueous stock solution by the vaporization heat. Further, when the aerosol composition is used as a cooling-type aerosol composition that exerts a cooling effect after being discharged, a liquefied gas may be incorporated for adjusting the cooling temperature, the duration of cooling, and the like.

The liquefied gas is not particularly limited. Examples of the liquefied gas include: liquefied petroleum gases, such as propane, n-butane, isobutane, and mixtures thereof; dimethyl ether; hydrofluoroolefins, such as (E)-1,3,3,3-tetrafluoroprop-1-ene (HFO-1234ze(E)), and 2,3,3,3-tetrafluoroprop-1-ene (HFO-1234yf); and mixtures of these gases. The liquefied gas may contain a hydrocarbon or an HFO, which has a boiling point of from 5 to 40° C., for further adjusting the cooling temperature, the duration of cooling, and the like. Examples of the hydrocarbon having a boiling point of from 5 to 40° C. include n-pentane and isopentane. Examples of the HFO having a boiling point of from 5 to 40° C. include (Z)-1,1,1,4,4,4-hexafluoro-2-butene (HFO-1336mzz(Z)) and (E)-1,1,1,4,4,4-hexafluoro-2-butene (HFO-1336mzz(E)).

(Flammability of Aerosol Composition)

When the aerosol composition of the disclosure is subjected to the below-described flame generation condition test in which a measurement aerosol product 2 produced by the below-described method is used as a sample, a sprayed content has a flame length of preferably less than 4.0 cm, more preferably 3.5 cm or less, still more preferably 3.0 cm or less, yet still more preferably 2.5 cm or less, further preferably 2.0 cm or less, still further preferably 1.5 cm or less, further more preferably 1.0 cm or less, still further more preferably 0.5 cm or less, particularly preferably 0 cm.
Production of Measurement Aerosol Product 2

As a spray container, a tin spray container which includes a container body, a valve mechanism having a stem orifice diameter of 0.45 mm, a discharge member having a discharge orifice diameter of 0.6 mm, and a spray tube having an inner diameter of 1.0 mm is used.

The aerosol composition is filled into the tin spray container such that the pressure inside the spray container is 0.6 MPa at 25° C., whereby the measurement aerosol product 2 is produced.
Flame Generation Condition Test

A flame generation condition test is conducted in accordance with the procedure prescribed in JIS S3301(2018) 6.5, except that a spray nozzle of the measurement aerosol product used as a sample is positioned 5 cm away from a flame burner.

Specifically, the measurement aerosol product used as a sample is immersed for at least 30 minutes in a thermostat water bath controlled at 25° C. ±0.5° C. to adjust the aerosol composition in the aerosol product to have a constant temperature. Subsequently, the flame burner is controlled to have a flame vertical length of from 4.5 cm to 5.5 cm, and the height of the spray nozzle of the measurement aerosol product is adjusted such that, in a favorable spray condition (i.e. spray pattern), the aerosol composition contained in the measurement aerosol product passes through an upper one-third of the flame of the flame burner.

The horizontal length L1 of the upper one-third of the flame is measured when the aerosol composition, which is a content of the measurement aerosol product, is sprayed, and the horizontal length L2 of the upper one-third of the flame is measured when the aerosol composition is not sprayed. Specifically, the behavior of the flame during the flame generation condition test is video-recorded with a scaled stand being placed on the back, and the thus recorded image is analyzed. A difference between L1 and L2 (L1−L2) is defined as the flame length of the sprayed content.

Even when the aerosol composition of the disclosure contains water, the flame length of the sprayed content in the above-described flame generation condition test can be shortened by using 1224yd that can reduce the flammability of the aerosol composition.

In addition, the flame length of the sprayed content in the above-described flame generation condition test can be further shortened by adjusting the pressure inside the container body in which the aerosol composition is stored. Specifically, the pressure inside the container at 25° C. is preferably 0.2 MPa or higher, more preferably 0.4 MPa or higher, still more preferably 0.6 MPa or higher.

The flame length of the sprayed content in the above-described flame generation condition test may vary depending on the type of the at least one of the compressed gas or the liquefied gas that is contained in the aerosol composition. Examples of the compressed gas that is selected from the standpoint of obtaining an aerosol composition having a short flame length of its sprayed content include nitrogen, air, oxygen, carbon dioxide, and nitrous oxide, among which nitrogen, air, oxygen, and nitrous oxide are preferred, nitrogen and carbon dioxide are more preferred, and nitrogen is still more preferred. Examples of the liquefied gas that is selected from the standpoint of obtaining an aerosol composition having a short flame length of its sprayed content include dimethyl ether and hydrofluoroolefins such as 1234ze(E) and 1234yf, among which hydrofluoroolefins such as 1234ze(E) and 1234yf are preferred.

A preferred composition is described below for each use of the aerosol composition.

<Foamy Aerosol Composition (1)>

A foamy aerosol composition (1) has excellent foamability and forms a foam that has a fine texture and can be easily spread. The foamy aerosol composition (1) is used in foam skin care sprays and foam hair care sprays.

(Water)

Water is used as a solvent. By containing water, the foamy aerosol composition can form a foam when discharged, and is easily spread over its application spot, such as hair or the arm.

The content of water is preferably not less than 10.0% by mass, more preferably not less than 25.0% by mass, still more preferably not less than 30.0% by mass, with respect to a total amount of water and 1224yd. The content of water is also preferably 97.0% by mass or less, more preferably 95.0% by mass or less, still more preferably 90.0% by mass or less, with respect to a total amount of water and 1224yd.

When the content of water is in this range, the foamy aerosol composition exhibits excellent foamability, and it is easy to incorporate 1224yd in an appropriate amount.

(1224yd)

In a container body, 1224yd is emulsified with water in the form of fine emulsified particles, and dissolves a compressed gas. When discharged to the outside, 1224yd is vaporized and causes the aerosol raw material composition to foam.

Since the boiling point of 1224yd(Z) is 15° C. and that of 1224yd(E) is 17° C., 1224yd is usually not instantaneously vaporized and thus has poor foamability; however, discharge of the compressed gas, which is dissolved in 1224yd in the container body, into the atmosphere leads to a reduction in the dissolved amount and the compressed gas becomes fine bubbles, and vaporization of 1224yd is facilitated in association with the generation of bubbles. In this process, 1224yd is in the form of fine particles and emulsified in the aerosol raw material composition; therefore, 1224yd is foamed to generate a foam having a fine texture. Further, this foam is likely to be efficiently cooled into a cold foam by the vaporization heat of 1224yd.

The content of 1224yd is preferably not less than 3.0% by mass, more preferably not less than 5.0% by mass, still more preferably not less than 10.0% by mass, with respect to a total amount of water and 1224yd. The content of 1224yd is also preferably 90.0% by mass or less, more preferably 85.0% by mass or less, still more preferably 80.0% by mass or less, with respect to a total amount of water and 1224yd.

When the content of 1224yd is in this range, 1224yd is likely to form a stable emulsified product with water, and the foamy aerosol composition exhibits more excellent foamability and is likely to form a cold foam.

(Surfactant)

A surfactant is preferably incorporated as an emulsifier that emulsifies 1224yd with the aqueous component of the aerosol raw material composition. In addition, the surfactant is preferably incorporated for the purposes of, for example, forming a foam by, when discharged to the outside, causing the compressed gas dissolved in the aerosol raw material composition to become fine bubbles and be dispersed, facilitating vaporization of 1224yd, which is emulsified with the aqueous component of the aerosol raw material composition, through the generation of bubbles, and thereby allowing the aerosol raw material composition to foam.

The surfactant is not particularly limited, and any of the above-exemplified surfactants can be used. Thereamong, as the surfactant, anionic surfactants, amino acid-based anionic surfactants, and nonionic surfactants are preferred since these surfactants readily emulsify 1224yd, improve the foamability of the resulting foamy aerosol composition, and are capable of forming a foam having a fine texture and a stable shape.

The content of the surfactant is not particularly limited. For example, the content of the surfactant is preferably not less than 0.1% by mass, more preferably not less than 0.5% by mass, with respect to a total mass of the aerosol raw material composition contained in the foamy aerosol composition. The content of the surfactant is also preferably 20% by mass or less, more preferably 15% by mass or less, with respect to a total mass of the aerosol raw material composition contained in the foamy aerosol composition.

(Optional Components)

In addition to the above-described water, 1224yd, and surfactant, the aerosol raw material composition contained in the foamy aerosol composition may also contain, as appropriate, optional components such as an active ingredient, an alcohol, a monosaccharide, a water-soluble polymer, an oil agent, a powder, and a preservative.

The active ingredient can be selected as appropriate in accordance with the intended use and purpose of the foamy aerosol composition. Examples of the active ingredient include: various fragrances, such as natural fragrances and synthetic fragrances; styling agents, for example, amphoteric resins such as dialkyl aminoalkyl (meth)acrylate-alkyl (meth)acrylate copolymers and acrylic acid alkyl amide-hydroxyalkyl acrylate-alkyl aminoalkyl methacrylate copolymers, and emulsion-type resins such as alkyl acrylate copolymer emulsions, alkyl acrylate-styrene copolymer emulsions, vinylpyrrolidone-styrene copolymer emulsions, and acrylic acid-hydroxyacrylate copolymer emulsions; refreshing agents, such as l-menthol, camphor, and mentha oil; vitamins, such as retinol, retinol acetate, retinol palmitate, calcium pantothenate, ascorbic acid magnesium phosphate, sodium ascorbate, dl-α-tocopherol, tocopherol acetate, tocopherol, tocopherol nicotinate, dibenzoyl thiamine, riboflavin, and mixtures thereof; antioxidants, such as ascorbic acid, α-tocopherol, dibutylhydroxytoluene, and butylhydroxyanisole; amino acids, such as glycine, alanine, leucine, serine, tryptophan, cysteine, methionine, aspartic acid, glutamic acid, and arginine; moisturizers, such as collagen, hyaluronic acid, charonic acid, sodium lactate, dl-pyrrolidone carboxylate, keratin, casein, lecithin, and urea; disinfectants, such as p-hydroxybenzoic acid esters, sodium benzoate, potassium sorbate, phenoxyethanol, benzalkonium chloride, benzethonium chloride, chlorhexidine chloride, and p-chloro-m-cresol; extracts, such as royal jelly extract, peony extract, Luffa cylindrica extract, rose extract, lemon extract, aloe extract, calamus root extract, Eucalyptus extract, sage extract, tea extract, seaweed extract, placenta extract, and silk extract; astringent agents, such as zinc oxide, allantoin hydroxyaluminum, tannic acid, citric acid, and lactic acid; anti-inflammatory agents, such as allantoin, glycyrrhetinic acid, dipotassium glycyrrhizate, and azulene; deodorants, such as lauryl methacrylate, methyl benzoate, methyl phenyl acetate, geranyl crotonate, acetophenone myristate, benzyl acetate, benzyl propionate, and green tea extract; ultraviolet absorbers, such as hexyl diethylaminohydroxybenzoyl benzoate, 2-ethylhexyl p-methoxycinnamate, ethylhexyl triazone, oxybenzone, hydroxybenzophenone sulfonic acid, sodium dihydroxybenzophenone sulfonate, and dihydroxybenzophenone; ultraviolet scattering agents, such as zinc oxide, titanium oxide, and octyltrimethoxysilane-coated titanium oxide; skin whitening agents, such as arbutin and kojic acid; pest repellents, such as N,N-diethyl-m-toluamide (DEET), di-n-butyl succinate, hydroxyanisole, rotenone, ethyl butylacetyl aminopropionate, icaridin (picaridin), p-menthane-3,8-diol, ethyl 3-[acetyl(butyl)amino]propionate, and 1-methylpropyl 2-(2-hydroxyethyl)piperidine-1-carboxylate; antiperspirants, such as chlorohydroxyaluminum and isopropylmethylphenol; and anti-inflammatory analgesic agents, such as methyl salicylate, indomethacin, felbinac, and ketoprofen.

When an active ingredient is incorporated, the content thereof is not particularly limited. For example, the content of the active ingredient is preferably not less than 0.1% by mass, more preferably not less than 0.3% by mass, with respect to a total mass of the aerosol raw material composition contained in the foamy aerosol composition. The content of the active ingredient is also preferably 20.0% by mass or less, more preferably 15.0% by mass or less, with respect to a total mass of the aerosol raw material composition contained in the foamy aerosol composition. When the content of the active ingredient is in this range, the effects of incorporating the active ingredient are likely to be obtained, and the foamability of the foamy aerosol composition is unlikely to be deteriorated by the active ingredient.

An alcohol is preferably incorporated as a solvent of the active ingredient that is hardly soluble in water. In addition, the alcohol is preferably incorporated for the purposes of, for example, adjusting the foamability.

The alcohol is not particularly limited. Examples of the alcohol include: monohydric alcohols having from 2 to 3 carbon atoms, such as ethanol and isopropanol; and polyhydric alcohols, such as propylene glycol, 1,3-butylene glycol, hexylene glycol, glycerol, dipropylene glycol, and diglycerol.

When an alcohol is incorporated, the content thereof is not particularly limited. For example, the content of the alcohol is preferably not less than 1.0% by mass, more preferably not less than 3.0% by mass, with respect to a total mass of the aerosol raw material composition contained in the foamy aerosol composition. The content of the alcohol is also preferably 30.0% by mass or less, more preferably 25.0% by mass or less, with respect to a total mass of the aerosol raw material composition contained in the aerosol composition. When the content of the alcohol is in this range, the effects of incorporating the alcohol are likely to be obtained, and the foamability of the foamy aerosol composition is unlikely to be deteriorated by the alcohol.

A monosaccharide is preferably incorporated for the purposes of, for example, adjusting the foamability.

The monosaccharide is not particularly limited. Examples of the monosaccharide include: sugar alcohols, such as erythritol, arabitol, galactitol, glucitol, maltitol, mannitol, sorbitol, and xylitol; tetroses, such as erythritol, D-erythrose, and D-threose; pentoses, such as D-arabinose, L-arabinose, D-xylose, D-lyxose, L-lyxose, D-ribose, D-xylulose, L-xylulose, D-ribulose, and L-ribulose; and hexoses, such as D-altrose, L-altrose, D-galactose, L-galactose, D-glucose, D-talose, L-sorbose, D-tagatose, D-psicose, D-fructose, and D-mannose.

When a monosaccharide is incorporated, the content thereof is not particularly limited. For example, the content of the monosaccharide is preferably not less than 0.5% by mass, more preferably not less than 1.0% by mass, with respect to a total mass of the aerosol raw material composition contained in the foamy aerosol composition. The content of the monosaccharide is also preferably 20.0% by mass or less, more preferably 10.0% by mass or less, with respect to a total mass of the aerosol raw material composition contained in the foamy aerosol composition. When the content of the monosaccharide is in this range, the effects of incorporating the monosaccharide are likely to be obtained.

A water-soluble polymer is preferably incorporated for the purposes of, for example, improving the foamability of the foamy aerosol composition and adjusting the retention force, hardness, elasticity, extensibility, and the like of the resulting foam.

The water-soluble polymer is not particularly limited. Examples of the water-soluble polymer include: cationic polymers, such as hydroxyethylcellulose dimethyldiallylammonium chloride (polyquaternium-4), dimethyldiacrylammonium chloride-acrylamide copolymer (polyquaternium-7), O-[2-hydroxy-3-(trimethylammonio)propyl]hydroxyethylcellulose chloride (polyquaternium-10), dimethyldiallylammonium chloride-acrylic acid copolymer (polyquaternium-22), O-[2-hydroxy-3-(lauryldimethylammonio)propyl]hydroxyethylcellulose chloride (polyquaternium-24), acrylamide-acrylic acid-dimethyldiallylammonium chloride copolymer (polyquaternium 39), 2-methacryloyloxyethyl phosphorylcholine-butyl methacrylate copolymer solution (polyquaternium-51), N,N-dimethylaminoethyl methacrylate diethyl sulfate/N,N-dimethylacrylamide/polyethylene glycol dimethacrylate (polyquaternium-52), 2-methacryloyloxyethyl phosphorylcholine-stearyl methacrylate copolymer (polyquaternium-61), and a copolymer of methacryloyloxyethylene phosphorylcholine, butyl methacrylate, and sodium methacrylate (polyquaternium-65); cellulose-based polymers, such as hydroxyethyl cellulose, hydroxypropyl cellulose, hydroxypropyl methylcellulose, and sodium carboxymethyl cellulose; gum substances, such as xanthan gum, carrageenan, gum arabic, gum tragacanth, cationized guar gum, guar gum, and gellan gum; dextran; sodium carboxymethyl dextran; dextrin; pectin; sodium alginate; sodium hyaluronate; polyvinyl alcohols; and carboxyvinyl polymers.

When a water-soluble polymer is incorporated, the content thereof is not particularly limited. For example, the content of the water-soluble polymer is preferably not less than 0.01% by mass, more preferably not less than 0.05% by mass, with respect to a total mass of the aerosol raw material composition contained in the foamy aerosol composition. The content of the water-soluble polymer is also preferably 5.0% by mass or less, more preferably 3.0% by mass or less, with respect to a total mass of the aerosol raw material composition contained in the foamy aerosol composition. When the content of the water-soluble polymer is in this range, the effects of incorporating the water-soluble polymer are likely to be obtained, and the viscosity of the aerosol raw material composition contained in the foamy aerosol composition is not excessively high, so that the foamability is unlikely to be deteriorated.

An oil agent is preferably incorporated for the purposes of, for example, softening the touch to the skin of the resulting foam and improving the combability.

The oil agent is not particularly limited. Examples of the oil agent include: silicone oils, such as dimethicone, methylpolysiloxane, cyclopentasiloxane, cyclohexasiloxane, octamethylcyclotetrasiloxane, decamethylcyclopentasiloxane, dodecamethylcyclohexasiloxane, methylcyclopolysiloxane, tetrahydrotetramethylcyclotetrasiloxane, octamethyltrisiloxane, decamethyltetrasiloxane, methyl hydrogen polysiloxane, and methylphenylpolysiloxane; hydrocarbon oils, such as liquid paraffin and isoparaffin; ester oils, such as methylpentanediol dineopentanoate, diethylpentanediol dineopentanoate, neopentyl glycol di-2-ethyl hexanoate, neopentyl glycol dicaprate, propylene glycol dilaurate, ethylene glycol distearate, diethylene glycol dilaurate, diethylene glycol distearate, diethylene glycol diisostearate, diethylene glycol dioleate, triethylene glycol dilaurate, triethylene glycol distearate, triethylene glycol diisostearate, triethylene glycol dioleate, propylene glycol monostearate, propylene glycol monooleate, ethylene glycol monostearate, glyceryl tri-2-ethyl hexanoate, tri(caprylic/capric acid) glycerin, isononyl isononanoate, isotridecyl isononanoate, diethoxyethyl succinate, diisostearyl malate, isopropyl myristate, isopropyl palmitate, cetyl isooctanoate, octyl hydroxystearate, and ethylhexyl hydroxystearate; fatty oils, such as olive oil, camellia oil, corn oil, castor oil, safflower oil, jojoba oil, and coconut oil; fatty acids, such as isostearic acid and oleic acid; and higher alcohols, such as oleyl alcohol and isostearyl alcohol.

When an oil agent is incorporated, the content thereof is not particularly limited. For example, the content of the oil agent is preferably not less than 0.1% by mass, more preferably not less than 0.5% by mass, with respect to a total mass of the aerosol raw material composition contained in the foamy aerosol composition. The content of the oil agent is also preferably 20.0% by mass or less, more preferably 10.0% by mass or less, with respect to a total mass of the aerosol raw material composition contained in the foamy aerosol composition. When the content of the oil agent is in this range, the effects of incorporating the oil agent are likely to be obtained. In addition, the foamability and the drying properties of the foamy aerosol composition are unlikely to be deteriorated, and the foamy aerosol composition is unlikely to cause stickiness.

A powder is preferably incorporated for improving the usability by, for example, providing a silky feel.

The powder is not particularly limited. Examples of the powder include talc, zinc oxide, titanium oxide, silica, zeolite, kaolin, mica, magnesium carbonate, calcium carbonate, zinc silicate, magnesium silicate, aluminum silicate, and calcium silicate.

When a powder is incorporated, the content thereof is not particularly limited. For example, the content of the powder is preferably not less than 0.1% by mass, more preferably not less than 0.3% by mass, with respect to a total mass of the aerosol raw material composition contained in the foamy aerosol composition. The content of the powder is also preferably 5.0% by mass or less, more preferably 3.0% by mass or less, with respect to a total mass of the aerosol raw material composition contained in the foamy aerosol composition. When the content of the powder is in this range, the effects of incorporating the powder are likely to be obtained, and the foamy aerosol composition is unlikely to cause clogging in a discharge passage when discharged.

A preservative is preferably incorporated for improving the storage properties of the foamy aerosol composition.

The preservative is not particularly limited. Examples of the preservative include methylparaben (i.e. methyl p-hydroxybenzoate), ethylparaben (i.e. ethyl p-hydroxybenzoate), benzalkonium chloride, and o-cymen-5-ol (i.e. isopropylmethylphenol).

When a preservative is incorporated, the content thereof is not particularly limited. For example, the content of the preservative is preferably not less than 0.0001% by mass, more preferably not less than 0.001% by mass, with respect to a total mass of the aerosol raw material composition contained in the foamy aerosol composition. The content of the preservative is also preferably 1.0% by mass or less, more preferably 0.5% by mass or less, with respect to a total mass of the aerosol raw material composition contained in the foamy aerosol composition. When the content of the preservative is in this range, for example, deterioration and foul smell of an aerosol product caused by proliferation of microbes accidentally entering the aerosol product can be inhibited.

(Compressed Gas)

A compressed gas is preferably incorporated as a propellant that pressurizes and discharges the aerosol raw material composition contained in the foamy aerosol composition to the outside. In addition, the compressed gas is partially dissolved in the aerosol raw material composition, and this causes the dissolved compressed gas to become fine bubbles after discharge of the aerosol raw material composition contained in the foamy aerosol composition to the outside, and to act as a foaming agent that facilitates vaporization of 1224yd and forms a foam by allowing the aerosol raw material composition contained in the foamy aerosol composition to foam.

The compressed gas is not particularly limited, and any of the above-exemplified gases can be used.

Particularly, the compressed gas is also dissolved in 1224yd emulsified with the aqueous component of the aerosol raw material composition contained in the foamy aerosol composition in a container body, whereby the compressed gas becomes fine bubbles in association with a reduction in its saturated dissolved amount when discharged to the outside, and facilitates vaporization of 1224yd. As a result, the compressed gas can cause the aerosol raw material composition contained in the foamy aerosol composition to generate a foam having a fine texture. In this manner, when a large amount of the compressed gas is dissolved in 1224yd, the aerosol raw material composition contained in the foamy aerosol composition is consequently allowed to form a foam having a fine texture; therefore, the compressed gas preferably contains a highly soluble compressed gas having an Ostwald coefficient of 0.4 or more for water at 25° C., more preferably contains a highly soluble compressed gas having an Ostwald coefficient of 0.5 or more for water at 25° C. Examples of such a highly soluble compressed gas include carbon dioxide gas (Ostwald coefficient: nitrous oxide gas (Ostwald coefficient: 0.59), and a mixed gas thereof, among which carbon dioxide is preferred.

The compressed gas preferably contains a poorly soluble compressed gas having an Ostwald coefficient of 0.05 or less for water at 25° C., more preferably contains a poorly soluble compressed gas having an Ostwald coefficient of 0.03 or less for water at 25° C., since such a compressed gas has excellent stability at low temperatures and, particularly, becomes fine bubbles when discharged and is likely to facilitate vaporization of 1224yd and form a foam having a finer texture. Examples of such a poorly soluble compressed gas include nitrogen (Ostwald coefficient: 0.0141), air (Ostwald coefficient: 0.0167), oxygen (Ostwald coefficient: 0.0283), and hydrogen (Ostwald coefficient: 0.0194), among which nitrogen is preferred. Further, a poorly soluble compressed gas is preferably used when the surfactant contained in the aerosol raw material composition is an anionic surfactant. By incorporating an anionic surfactant as the surfactant and using a poorly soluble compressed gas as the compressed gas, the foamy aerosol composition is provided with excellent stability at low temperatures and superior foamability and made more likely to form a foam having a fine texture. In addition, this foamy aerosol composition has a higher safety when a poorly soluble compressed gas such as nitrogen gas is used.

The compressed gas is filled into a container body such that the pressure inside the container body at 25° C. is preferably 0.2 MPa or higher, more preferably 0.3 MPa or higher. Further, the compressed gas is filled into the container body such that the pressure inside the container body at 25° C. is preferably 0.8 MPa or lower, more preferably 0.7 MPa or lower. By filling the compressed gas such that the pressure is in this range, the compressed gas is moderately dissolved in the aerosol raw material composition contained in the foamy aerosol composition and made likely to generate bubbles when discharged. Therefore, when the compressed gas is filled such that the pressure is in the above-described range, the foamy aerosol composition is not only likely to exhibit excellent foamability but also unlikely to be scattered when discharged.

<Foamy Aerosol Composition (2)>

A foamy aerosol composition (2) gives a pleasant stimulation when its foam breaks, and provides a moderate and persistent cooling sensation.

(Water)

Water is used as a solvent. By containing water, the foamy aerosol composition, when discharged, can form a foam due to release of the compressed gas dissolved in the aerosol raw material composition contained in the foamy aerosol composition and vaporization of 1224yd. The foam is broken at its application spot such as hair or arm, and can give a pleasant stimulation.

The content of water is preferably not less than 5.0% by mass, more preferably not less than 8.0% by mass, still more preferably not less than 10.0% by mass, with respect to a total amount of water and 1224yd. The content of water is also preferably 60.0% by mass or less, more preferably 55.0% by mass or less, still more preferably 50.0% by mass or less, with respect to a total amount of water and 1224yd.

When the content of water is in this range, the foamy aerosol composition exhibits excellent formability and is likely to give a pleasant stimulation and a cooling sensation when applied.

(1224yd)

In a container body, 1224yd is emulsified with water in the form of fine emulsified particles, and dissolves a compressed gas. When discharged to the outside, 1224yd is vaporized and causes the aerosol raw material composition contained in the foamy aerosol composition to foam.

The content of 1224yd is preferably not less than 40.0% by mass, more preferably not less than 45.0% by mass, still more preferably not less than 50.0% by mass, with respect to a total amount of water and 1224yd. When the content of 1224yd is 40.0% by mass or less, the amount of the compressed gas dissolving in 1224yd is not reduced and the stimulation by foam breakage does not decrease, so that the foamy aerosol composition is likely to provide a persistent cooling sensation. The content of 1224yd is also preferably 95.0% by mass or less, more preferably 92.0% by mass or less, still more preferably 90.0% by mass or less, with respect to a total amount of water and 1224yd. When the content of 1224yd is 95.0% by mass or less, the foamy aerosol composition is easily foamed, and a stimulation is likely to be obtained by foam breakage.

(Surfactant)

A surfactant is preferably incorporated as an emulsifier that emulsifies 1224yd with the aqueous component of the aerosol raw material composition contained in the aerosol composition. In addition, the surfactant is preferably incorporated for the purposes of, for example, forming a foam by, when discharged to the outside, causing the compressed gas dissolved in the aerosol raw material composition contained in the aerosol composition to become fine bubbles and be dispersed, facilitating vaporization of 1224yd, which is emulsified with the aqueous component of the aerosol raw material composition, through the generation of bubbles, and thereby allowing the aerosol raw material composition to foam.

The surfactant is not particularly limited, and any of the above-exemplified surfactants can be used. Thereamong, as the surfactant, anionic surfactants, amino acid-based anionic surfactants, and nonionic surfactants are preferred since these surfactants readily emulsify 1224yd, improve the foamability of the resulting foamy aerosol composition, and are capable of forming a foam having a fine texture and a stable shape.

The content of the surfactant is not particularly limited. For example, the content of the surfactant is preferably not less than 0.1% by mass, more preferably not less than 0.5% by mass, with respect to a total mass of the aerosol raw material composition contained in the foamy aerosol composition. The content of the surfactant is also preferably 20.0% by mass or less, more preferably 15.0% by mass or less, with respect to a total mass of the aerosol raw material composition contained in the foamy aerosol composition.

(Optional Components)

In addition to the above-described water, 1224yd, and surfactant, the aerosol raw material composition may also contain, as appropriate, optional components such as an active ingredient, an alcohol, a water-soluble polymer, an oil agent, a powder, and a preservative.

The active ingredient can be selected as appropriate in accordance with the intended use and purpose of the foamy aerosol composition. Examples of the active ingredient include: hair restorers, such as minoxidil and adenosine; vasodilators, such as carpronium chloride, benzyl nicotinate, Swertia japonica extract, and capsicum tincture; vitamins, such as retinol, retinol acetate, retinol palmitate, calcium pantothenate, panthenol, ascorbic acid magnesium phosphate, sodium ascorbate, dl-α-tocopherol, tocopherol acetate, tocopherol, tocopherol nicotinate, dibenzoyl thiamine, riboflavin, and mixtures thereof; antioxidants, such as ascorbic acid, α-tocopherol, dibutylhydroxytoluene, butylhydroxyanisole, and sodium edetate; keratolytic agents, such as urea and salicylic acid; moisturizers, such as collagen, hyaluronic acid, sodium hyaluronate, chondroitin sulfate, and heparin analogues; fungicides, such as isopropylmethylphenol, chlorhexidine gluconate, p-hydroxybenzoic acid esters, sodium benzoate, potassium sorbate, phenoxyethanol, benzalkonium chloride, benzethonium chloride, chlorhexidine chloride, and p-chloro-m-cresol; extracts, such as royal jelly extract, peony extract, Luffa cylindrica extract, rose extract, lemon extract, aloe extract, calamus root extract, Eucalyptus extract, sage extract, tea extract, seaweed extract, placenta extract, Saussurea root extract, Glycyrrhiza extract, and Hypericum perforatum extract; refreshing agents, such as 1-menthol, camphor, and mentha oil; astringent agents, such as zinc oxide, allantoin hydroxyaluminum, tannic acid, citric acid, and lactic acid; anti-inflammatory agents, such as allantoin, glycyrrhetinic acid, dipotassium glycyrrhizate, and azulene; deodorants, such as lauryl methacrylate, methyl benzoate, methyl phenyl acetate, geranyl crotonate, acetophenone myristate, benzyl acetate, benzyl propionate, and green tea extract; ultraviolet absorbers, such as hexyl diethylaminohydroxybenzoyl benzoate, 2-ethylhexyl p-methoxycinnamate, ethylhexyl triazone, oxybenzone, hydroxybenzophenone sulfonic acid, sodium dihydroxybenzophenone sulfonate, and dihydroxybenzophenone; ultraviolet scattering agents, such as zinc oxide, titanium oxide, and octyltrimethoxysilane-coated titanium oxide; pest repellents, such as N,N-diethyl-m-toluamide (DEET), di-n-butyl succinate, hydroxyanisole, rotenone, ethyl butylacetyl aminopropionate, icaridin (picaridin), p-menthane-3,8-diol, ethyl 3-[acetyl(butyl)amino]propionate, and 1-methylpropyl 2-(2-hydroxyethyl)piperidine-1-carboxylate; antiperspirants, such as chlorohydroxyaluminum and isopropylmethylphenol; anti-inflammatory analgesic agents, such as methyl salicylate, indomethacin, felbinac, and ketoprofen; and various fragrances, such as natural fragrances and synthetic fragrances.

When an active ingredient is incorporated, the content thereof is not particularly limited. For example, the content of the active ingredient is preferably not less than 0.1% by mass, more preferably not less than 0.3% by mass, with respect to a total mass of the aerosol raw material composition contained in the foamy aerosol composition. The content of the active ingredient is also preferably 30.0% by mass or less, more preferably 25.0% by mass or less, with respect to a total mass of the aerosol raw material composition contained in the foamy aerosol composition. When the content of the active ingredient is in this range, the effects of incorporating the active ingredient are likely to be obtained, and the foamability of the foamy aerosol composition is unlikely to be deteriorated by the active ingredient.

An alcohol is preferably incorporated as a solvent of the active ingredient that is hardly soluble in water. In addition, the alcohol is preferably incorporated for the purposes of, for example, adjusting the foamability and adjusting the stimulation made at the time of foam breakage.

The alcohol is not particularly limited. Examples of the alcohol include: monohydric alcohols having from 2 to 3 carbon atoms, such as ethanol and isopropanol; and polyhydric alcohols, such as propylene glycol, 1,3-butylene glycol, hexylene glycol, glycerol, dipropylene glycol, and diglycerol.

When an alcohol is incorporated, the content thereof is not particularly limited. For example, the content of the alcohol is preferably not less than 1.0% by mass, more preferably not less than 2.0% by mass, with respect to a total mass of the aerosol raw material composition contained in the foamy aerosol composition. The content of the alcohol is also preferably 30.0% by mass or less, more preferably 25.0% by mass or less, with respect to a total mass of the aerosol raw material composition contained in the foamy aerosol composition. When the content of the alcohol is in this range, the effects of incorporating the alcohol are likely to be obtained, and the foamability of the foamy aerosol composition is unlikely to be deteriorated by the alcohol.

A water-soluble polymer is preferably incorporated for the purposes of, for example, strengthening a foam film and enhancing the sound and the stimulation that are made at the time of foam breakage so as to make a massage sensation more likely to be obtained.

The water-soluble polymer is not particularly limited. Examples of the water-soluble polymer include: cellulose-based polymers, such as hydroxymethyl cellulose, hydroxyethyl cellulose, hydroxypropyl cellulose, hydroxypropyl methylcellulose, sodium carboxymethyl cellulose, and cellulose nanofibers; gum substances, such as xanthan gum, carrageenan, gum arabic, gum tragacanth, cationized guar gum, guar gum, and gellan gum; dextran; sodium carboxymethyl dextran; dextrin; pectin; sodium alginate; sodium hyaluronate; polyvinyl alcohols; and carboxyvinyl polymers.

When a water-soluble polymer is incorporated, the content thereof is not particularly limited. For example, the content of the water-soluble polymer is preferably not less than by mass, more preferably not less than 0.03% by mass, with respect to a total mass of the aerosol raw material composition contained in the foamy aerosol composition. The content of the water-soluble polymer is also preferably 5.0% by mass or less, more preferably 3.0% by mass or less, with respect to a total mass of the aerosol raw material composition contained in the foamy aerosol composition. When the content of the water-soluble polymer is in this range, the effects of incorporating the water-soluble polymer are likely to be obtained, and the viscosity of the aerosol raw material composition contained in the foamy aerosol composition is not excessively high, so that the foamability is unlikely to be deteriorated.

An oil agent is preferably incorporated for the purposes of, for example, adjusting the release condition of the dissolved compressed gas and adjusting the sound and the stimulation that are made at the time of foam breakage.

The oil agent is not particularly limited. Examples of the oil agent include: silicone oils, such as dimethicone, methylpolysiloxane, cyclopentasiloxane, cyclohexasiloxane, octamethylcyclotetrasiloxane, decamethylcyclopentasiloxane, dodecamethylcyclohexasiloxane, methylcyclopolysiloxane, tetrahydrotetramethylcyclotetrasiloxane, octamethyltrisiloxane, decamethyltetrasiloxane, methyl hydrogen polysiloxane, and methylphenylpolysiloxane; hydrocarbon oils, such as liquid paraffin and isoparaffin; ester oils, such as methylpentanediol dineopentanoate, diethylpentanediol dineopentanoate, neopentyl glycol di-2-ethyl hexanoate, neopentyl glycol dicaprate, propylene glycol dilaurate, ethylene glycol distearate, diethylene glycol dilaurate, diethylene glycol distearate, diethylene glycol diisostearate, diethylene glycol dioleate, triethylene glycol dilaurate, triethylene glycol distearate, triethylene glycol diisostearate, triethylene glycol dioleate, propylene glycol monostearate, propylene glycol monooleate, ethylene glycol monostearate, glyceryl tri-2-ethyl hexanoate, tri(caprylic/capric acid) glycerin, isononyl isononanoate, isotridecyl isononanoate, diethoxyethyl succinate, diisostearyl malate, isopropyl myristate, isopropyl palmitate, cetyl isooctanoate, octyl hydroxystearate, and ethylhexyl hydroxystearate; fatty oils, such as olive oil, camellia oil, corn oil, castor oil, safflower oil, jojoba oil, and coconut oil; fatty acids, such as isostearic acid and oleic acid; and higher alcohols, such as oleyl alcohol and isostearyl alcohol.

When an oil agent is incorporated, the content thereof is not particularly limited. For example, the content of the oil agent is preferably not less than 0.1% by mass, more preferably not less than 0.5% by mass, with respect to a total mass of the aerosol raw material composition contained in the foamy aerosol composition. The content of the oil agent is also preferably 15.0% by mass or less, more preferably 10.0% by mass or less, with respect to a total mass of the aerosol raw material composition contained in the foamy aerosol composition. When the content of the oil agent is in this range, the effects of incorporating the oil agent are likely to be obtained. In addition, the foamability and the drying properties of the foamy aerosol composition are unlikely to be deteriorated, and the foamy aerosol composition is unlikely to cause stickiness.

A powder is preferably incorporated for the purposes of, for example, facilitating the emulsification of the aqueous component of the aerosol raw material composition contained in the foamy aerosol composition with 1224yd, conditioning the scalp environment by adsorption of sebum, and improving the usability by providing a silky feel.

The powder is not particularly limited. Examples of the powder include talc, zinc oxide, titanium oxide, silica, zeolite, kaolin, mica, magnesium carbonate, calcium carbonate, zinc silicate, magnesium silicate, aluminum silicate, and calcium silicate.

When a powder is incorporated, the content thereof is not particularly limited. For example, the content of the powder is preferably not less than 0.1% by mass, more preferably not less than 0.3% by mass, with respect to a total mass of the aerosol raw material composition contained in the foamy aerosol composition. The content of the powder is also preferably 10.0% by mass or less, more preferably 8.0% by mass or less, with respect to a total mass of the aerosol raw material composition contained in the foamy aerosol composition. When the content of the powder is in this range, the effects of incorporating the powder are likely to be obtained, and the foamy aerosol composition is unlikely to cause clogging in a discharge passage when discharged.

A preservative is preferably incorporated for improving the storage properties of the foamy aerosol composition.

The preservative is not particularly limited. Examples of the preservative include methylparaben (i.e. methyl p-hydroxybenzoate), ethylparaben (i.e. ethyl p-hydroxybenzoate), benzalkonium chloride, and o-cymen-5-ol (i.e. isopropylmethylphenol).

When a preservative is incorporated, the content thereof is not particularly limited. For example, the content of the preservative is preferably not less than 0.0001% by mass, more preferably not less than 0.001% by mass, with respect to a total mass of the aerosol raw material composition contained in the foamy aerosol composition. The content of the preservative is also preferably 1.0% by mass or less, more preferably 0.5% by mass or less, with respect to a total mass of the aerosol raw material composition contained in the foamy aerosol composition. When the content of the preservative is in this range, for example, deterioration and foul smell of an aerosol product caused by proliferation of microbes accidentally entering the aerosol product can be inhibited.

(Compressed Gas)

A compressed gas is preferably incorporated as a propellant that pressurizes and discharges the aerosol raw material composition contained in the foamy aerosol composition to the outside. In addition, the compressed gas is partially dissolved in the aerosol raw material composition contained in the foamy aerosol composition, and this causes the dissolved compressed gas to become fine bubbles after discharge of the aerosol raw material composition contained to the outside, and to act as a foaming agent that facilitates vaporization of 1224yd and forms a foam by allowing the aerosol raw material composition contained in the foamy aerosol composition to foam.

Particularly, the compressed gas is also dissolved in 1224yd emulsified with the aqueous component of the aerosol raw material composition contained in the aerosol composition in a container body, whereby the compressed gas becomes fine bubbles in association with a reduction in its saturated dissolved amount when discharged to the outside, and facilitates vaporization of 1224yd. As a result, the foamy aerosol composition is likely to give a pleasant stimulation when its foam breaks. In addition, the compressed gas is slowly released to allow vaporization of 1224yd to continue, so that a cooling sensation can be provided persistently.

The compressed gas is not particularly limited, and any of the above-exemplified gases can be used. Thereamong, the compressed gas preferably contains a highly soluble compressed gas such as carbon dioxide or nitrous oxide, more preferably contains at least one of carbon dioxide or nitrous oxide, still more preferably contains carbon dioxide, since such a compressed gas not only is dissolved in 1224yd in a large amount and increases the number of generated foam particles, making a pleasant stimulation more likely to be obtained, but also the dissolved compressed gas is released over an extended period and a cooling sensation is thus likely to be provided persistently. Further, the compressed gas preferably contains a poorly soluble compressed gas such as nitrogen, air, oxygen, or hydrogen, more preferably contains at least one of nitrogen, air, oxygen, or hydrogen, still more preferably contains nitrogen, since such a compressed gas makes the generated foam particles fine, so that a gentle stimulation is likely to be obtained.

The foamy aerosol composition may also contain a liquefied gas as a propellant, in addition to the above-described compressed gas. The liquefied gas is not particularly limited. Examples of the liquefied gas include: liquefied petroleum gases, such as propane, n-butane, isobutane, and mixtures thereof; dimethyl ether; hydrofluoroolefins, such as (E)-1,3,3,3-tetrafluoroprop-1-ene (HFO-1234ze(E)), and 2,3,3,3-tetrafluoroprop-1-ene (HFO-1234yf); and mixtures of these gases. The liquefied gas may contain a hydrocarbon or an HFO, which has a boiling point of from 5 to 40° C., for further adjusting the cooling temperature, the duration of cooling, and the like. Examples of the hydrocarbon having a boiling point of from 5 to 40° C. include n-pentane and isopentane. Examples of the HFO having a boiling point of from 5 to 40° C. include (Z)-1,1,1,4,4,4-hexafluoro-2-butene (HFO-1336mzz(Z)) and (E)-1,1,1,4,4,4-hexafluoro-2-butene (HFO-1336mzz(E)).

When a liquefied gas is incorporated, the content thereof is not particularly limited. For example, the content of the liquefied gas is preferably not less than 3.0% by mass, more preferably not less than 5.0% by mass, with respect to a total mass of the foamy aerosol composition excluding the compressed gas. The content of the liquefied gas is also preferably 30.0% by mass or less, more preferably 25.0% by mass or less, with respect to a total mass of the foamy aerosol composition excluding the compressed gas. When the content of the liquefied gas is in this range, the foamy aerosol composition does not have an excessively high vaporization rate when sprayed, so that a moderate cooling effect is likely to be maintained.

The compressed gas is filled into a container body such that the pressure inside the container body at 25° C. is preferably 0.2 MPa or higher, more preferably 0.3 MPa or higher. Further, the compressed gas is filled into the container body such that the pressure inside the container body at 25° C. is preferably 0.8 MPa or lower, more preferably 0.7 MPa or lower. By filling the compressed gas is filled such that the pressure is in this range, the compressed gas is moderately dissolved a stock solution and made likely to generate bubbles when discharged, so that a pleasant stimulation is likely to be obtained at the time of foam breakage.

<Freezing-Type Aerosol Composition>

A freezing-type aerosol composition can maintain a stable spray condition and yield a stable frozen product.

(Water)

Water is a main solvent of the aqueous component of the aerosol raw material composition contained in the freezing-type aerosol composition, and is frozen by the vaporization heat of 1224yd after the composition is sprayed.

The content of water is preferably not less than 30.0% by mass, more preferably not less than 40.0% by mass, still more preferably not less than 50.0% by mass, with respect to a total amount of water and 1224yd. When the content of water is 30.0% by mass or more, the aerosol raw material composition is likely to be emulsified. The content of water is also preferably 90.0% by mass or less, more preferably 88.0% by mass or less, still more preferably 85.0% by mass or less, with respect to a total amount of water and 1224yd. When the content of water is 90.0% by mass or less, it is easy to incorporate a surfactant and optional components used as appropriate into the composition.

(1224yd)

1224yd is incorporated for the purposes of, for example, adjusting the timing of the vaporization of a liquefied gas to create a stable spray condition in which the aqueous component of the aerosol raw material composition contained in the freezing-type aerosol composition does not freeze at a spray nozzle or the like and cause clogging of the spray nozzle, and preventing the sprayed freezing-type aerosol composition from freezing before reaching an application spot but allowing the sprayed freezing-type aerosol composition to freeze on the application spot.

The content of 1224yd is preferably not less than 10.0% by mass, more preferably not less than 12.0% by mass, still more preferably not less than 15.0% by mass, with respect to a total amount of water and 1224yd. As long as the content of 1224yd is 10.0% by mass or more, the timing of the vaporization of a liquefied gas is sufficiently adjusted. The content of 1224yd is also preferably 70.0% by mass or less, more preferably 60.0% by mass or less, still more preferably 50.0% by mass or less, with respect to a total amount of water and 1224yd. When the content of 1224yd is 70.0% by mass or less, the sprayed composition readily freezes.

(Surfactant)

A surfactant is a component used for emulsifying the aerosol raw material composition contained in the freezing-type aerosol composition inside a container body. When the freezing-type aerosol composition emulsified by the surfactant is sprayed, the vaporization heat generated by vaporization of 1224yd is likely to be transmitted to the water in the aerosol raw material composition contained in the freezing-type aerosol composition. As a result, the sprayed composition is likely to freeze.

The surfactant is not particularly limited. Examples of the surfactant include: nonionic surfactants, such as polyoxyethylene polyoxypropylene alkyl ethers, polyoxyethylene alkyl ethers, polyoxyethylene fatty acid esters, polyoxyethylene sorbitan fatty acid esters, polyoxyethylene glycerin fatty acid esters, polyoxyethylene sorbit fatty acid esters, polyglycerin fatty acid esters, and polyoxyethylene hardened castor oils; silicone-based surfactants; and natural surfactants.

Examples of the polyoxyethylene polyoxypropylene alkyl ethers include POE-POP cetyl ethers and POE-POP decyl tetradecyl ethers. Examples of the polyoxyethylene alkyl ethers include POE cetyl ethers, POE stearyl ethers, POE oleyl ethers, POE lauryl ethers, POE behenyl ethers, POE octyl dodecyl ethers, POE isocetyl ethers, and POE isostearyl ethers. Examples of the polyoxyethylene fatty acid esters include POE monolaurate, POE monostearate, and POE monooleate. Examples of the polyoxyethylene sorbitan fatty acid esters include PEG-20 sorbitan cocoate, POE sorbitan monolaurate, POE sorbitan monostearate, and POE sorbitan monooleate. Examples of the polyoxyethylene glycerin fatty acid esters include POE glyceryl monostearate and POE glyceryl monooleate. Examples of the polyoxyethylene sorbit fatty acid esters include POE sorbit monolaurate, POE sorbit tetrastearate, and POE sorbit tetraoleate. Examples of the polyglycerin fatty acid esters include decaglyceryl monolaurate, decaglyceryl monomyristate, decaglyceryl monostearate, decaglyceryl monooleate, decaglyceryl dioleate, hexaglyceryl monolaurate, hexaglyceryl monostearate, and hexaglyceryl monooleate. Examples of the polyoxyethylene hardened castor oils include PEG-40 hydrogenated castor oil, PEG-60 hydrogenated castor oil, and PEG-80 hydrogenated castor oil. Examples of the silicone-based surfactants include polyoxyethylene-methylpolysiloxane copolymers, polyoxypropylene-methylpolysiloxane copolymers, and poly(oxyethylene-oxypropylene)-methylpolysiloxane copolymers. Examples of the natural surfactants include sodium surfactin, cyclodextrin, and lecithin.

The content of the surfactant is not particularly limited, and may be any amount as long as the aerosol raw material composition contained in the freezing-type aerosol composition can be appropriately emulsified. The content of the surfactant is preferably not less than 0.1% by mass, more preferably not less than 0.3% by mass, with respect to a total mass of the aqueous component of the aerosol raw material composition contained in the freezing-type aerosol composition. When the content of the surfactant is 0.1% by mass or more, the aerosol raw material composition tends to be appropriately emulsified. The content of the surfactant is also preferably 15.0% by mass or less, more preferably 10.0% by mass or less, with respect to a total mass of the aqueous component of the aerosol raw material composition contained in the freezing-type aerosol composition. When the content of the surfactant is 15.0% by mass or less, the surfactant is unlikely to remain on an application spot after the freezing-type aerosol composition is sprayed to the application spot, so that the surfactant does not tend to cause deterioration of the usability, such as development of stickiness.

(Optional Components)

The freezing-type aerosol composition may also contain optional components, such as an alcohol, an active ingredient, a water-soluble polymer, an oil-based solvent, a powder, and a preservative, in addition to the above-described components.

An alcohol is incorporated as appropriate for the purposes of, for example, adjusting the freezing condition of a solvent of the active ingredient that is hardly soluble in water, and that of the sprayed composition.

The alcohol is not particularly limited. Examples of the alcohol include: monohydric alcohols having from 2 to 3 carbon atoms, such as ethanol and isopropanol; and di- to tri-hydric polyols, such as ethylene glycol, propylene glycol, 1,3-butylene glycol, dipropylene glycol, and glycerol.

When an alcohol is incorporated, the content thereof is preferably not less than 0.1% by mass, more preferably not less than 0.3% by mass, with respect to a total mass of the aqueous component of the aerosol raw material composition contained in the freezing-type aerosol composition. When the content of the alcohol is 0.1% by mass or more, the effects of incorporating the alcohol are likely to be obtained. The content of the alcohol is also preferably 30.0% by mass or less, more preferably 25.0% by mass or less, with respect to a total mass of the aqueous component of the aerosol raw material composition contained in the freezing-type aerosol composition. When the content of the alcohol is 30.0% by mass or less, the aerosol raw material composition contained in the freezing-type aerosol composition is likely to be emulsified, so that a frozen product is likely to be formed.

(Active Ingredient)

An active ingredient is incorporated as appropriate for imparting an application spot, such as skin or hair, with a desired effect.

Examples of the active ingredient include refreshing agents, antipruritic agents, anti-inflammatory analgesic agents, antifungal agents, astringent agents, anti-inflammatory agents, local anesthetic agents, antihistamine agents, blood circulation promoters, moisturizers, ultraviolet absorbers, ultraviolet scattering agents, disinfectants, amino acids, vitamins, antiperspirant components, pest repellents, deodorant components, cleaning agents, treatment agents, and fragrances.

Examples of the refreshing agents include l-menthol, camphor, and mentha oil. Examples of the antipruritic agents include crotamiton and d-camphor. Examples of the anti-inflammatory analgesic agents include methyl salicylate, indomethacin, piroxicam, felbinac, and ketoprofen. Examples of the antifungal agents include oxiconazole, clotrimazole, sulconazole, bifonazole, miconazole, isoconazole, econazole, tioconazole, and butenafine, as well as hydrochlorides, nitrates, and acetates thereof. Examples of the astringent agents include allantoin hydroxyaluminum, tannic acid, citric acid, and lactic acid.

Examples of the anti-inflammatory agents include allantoin, glycyrrhetinic acid, dipotassium glycyrrhizate, and azulene. Examples of the local anesthetic agents include dibucaine hydrochloride, tetracaine hydrochloride, lidocaine, and lidocaine hydrochloride. Examples of the antihistamine agents include diphenhydramine, diphenhydramine hydrochloride, and chlorpheniramine maleate. Examples of the blood circulation promoters include capsicum tincture, Swertia japonica extract, garlic extract, benzyl nicotinate, minoxidil, and carpronium chloride.

Examples of the moisturizers include collagen, xylitol, sorbitol, aloe extract, Ginkgo biloba extract, hyaluronic acid, sodium hyaluronate, sodium lactate, DL-pyrrolidone carboxylate, and urea. Examples of the ultraviolet absorbers include hexyl diethylaminohydroxybenzoyl benzoate, ethylhexyl dimethylamino benzoate, p-aminobenzoic acid, ethyl p-aminobenzoate, 2-ethylhexyl p-dimethylaminobenzoate, ethylhexyl salicylate, ethylhexyl methoxycinnamate, methyl diisopropylcinnamate, octocrylene, oxybenzone-3, oxybenzone-4, ethylhexyl dimethoxybenzylidene dioxoimidazolidine propionate, and phenylbenzimidazole sulfonic acid.

Examples of the ultraviolet scattering agents include titanium oxide and zinc oxide. Examples of the disinfectants include p-hydroxybenzoic acid esters, sodium benzoate, potassium sorbate, phenoxyethanol, benzalkonium chloride, benzethonium chloride, and chlorhexidine chloride. Examples of the amino acids include glycine, alanine, leucine, aspartic acid, glutamic acid, and arginine. Examples of the vitamins include tocopherol, tocopherol acetate, calcium pantothenate, magnesium ascorbyl phosphate, and sodium ascorbate. Examples of the antiperspirant components include chlorohydroxyaluminum, zinc p-phenolsulfonate, aluminum chloride, aluminum sulfate, aluminum citrate, aluminum acetate, and aluminum phenolsulfonate. Examples of the pest repellents include N,N-diethyl-m-toluamide (DEET) and herb extracts. Examples of the deodorant components include green tea extract, persimmon tannin, and silver.

Examples of the cleaning agents include amphoteric surfactants, anionic surfactants, and amino acid-based surfactants.

Examples of the amphoteric surfactants include betaine-type and amine oxide-type amphoteric surfactants. Examples of the betaine-type amphoteric surfactants include alkyl betaines, such as lauryl dimethylamino acetic acid betaine (lauryl betaine), stearyl betaine, lauric acid amide propyl betaine, lauryl hydroxysulfobetaine, stearyl dimethylamino acetic acid betaine, dodecyl aminomethyl dimethyl sulfopropyl betaine, and octadecyl aminomethyl dimethyl sulfopropyl betaine, as well as coconut acid amide propyl betaine, coconut oil fatty acid amide propyl dimethylamino acetic acid betaine (cocamidopropyl betaine), and cocamidopropyl hydroxysultaine.

When an active ingredient is incorporated, the content thereof is preferably not less than 0.01% by mass, more preferably not less than 0.10% by mass, with respect to a total mass of the aqueous component of the aerosol raw material composition contained in the freezing-type aerosol composition. When the content of the active ingredient is 0.01% by mass or more, the effects of incorporating the active ingredient are likely to be obtained. The content of the active ingredient is also preferably 30.0% by mass or less, more preferably 25.0% by mass or less, with respect to a total mass of the aqueous component of the aerosol raw material composition contained in the freezing-type aerosol composition. When the content of the active ingredient is 30.0% by mass or less, the aerosol raw material composition contained in the freezing-type aerosol composition is likely to be emulsified.

A water-soluble polymer adjusts the viscosity of the aqueous component of the aerosol raw material composition contained in the freezing-type aerosol composition, and stabilizes the emulsification of the aerosol raw material composition. Such a water-soluble polymer is incorporated as appropriate for the purposes of, for example, retaining 1224yd in the sprayed composition over an extended period to facilitate the freezing of the aqueous component of the aerosol raw material composition contained in the freezing-type aerosol composition, and adjusting the hardness, the solubility, and the like of the resulting frozen product.

The water-soluble polymer is not particularly limited. Examples of the water-soluble polymer include: cellulose-based polymers, such as hydroxymethyl cellulose, hydroxyethyl cellulose, hydroxypropyl cellulose, hydroxypropyl methylcellulose, sodium carboxymethyl cellulose, and cellulose nanofibers; gum substances, such as xanthan gum, carrageenan, gum arabic, gum tragacanth, cationized guar gum, guar gum, and gellan gum; dextran; sodium carboxymethyl dextran; dextrin; pectin; sodium alginate; sodium hyaluronate; polyvinyl alcohols; and carboxyvinyl polymers. When a water-soluble polymer is incorporated, the content thereof is preferably not less than 0.01% by mass, more preferably not less than 0.05% by mass, with respect to a total mass of the aqueous component of the aerosol raw material composition contained in the freezing-type aerosol composition. When the content of the water-soluble polymer is 0.01% by mass or more, the effects of incorporating the water-soluble polymer are likely to be obtained. The content of the water-soluble polymer is also preferably 5.0% by mass or less, more preferably 3.0% by mass or less, with respect to a total mass of the aqueous component of the aerosol raw material composition contained in the freezing-type aerosol composition. When the content of the water-soluble polymer is 5.0% by mass or less, the viscosity is not excessively high and the aerosol raw material composition contained in the freezing-type aerosol composition is thus likely to be emulsified, so that deterioration of the usability does not occur.

An oil-based solvent is incorporated as appropriate for the purposes of, for example, adjusting the condition of the sprayed composition, moisturizing an application spot (e.g., skin) to improve the usability, and dissolving the active ingredient that is hardly soluble in water.

Examples of the oil-based solvent include fatty oils, fatty acids, higher alcohols, ester oils, silicone oils, hydrocarbons, and mixtures thereof.

Examples of the fatty oils include olive oil, camellia oil, corn oil, castor oil, safflower oil, jojoba oil, and coconut oil. Examples of the fatty acids include myristic acid, stearic acid, and oleic acid. Examples of the higher alcohols include cetyl alcohol, oleyl alcohol, and isostearyl alcohol. Examples of the ester oils include isopropyl myristate, isopropyl palmitate, cetyl isooctanoate, methylpentanediol dineopentanoate, diethylpentanediol dineopentanoate, neopentyl glycol di-2-ethyl hexanoate, neopentyl glycol dicaprate, propylene glycol dilaurate, ethylene glycol distearate, propylene glycol monostearate, propylene glycol monooleate, ethylene glycol monostearate, glyceryl tri-2-ethyl hexanoate, tri(caprylic/capric acid) glycerin, isononyl isononanoate, isotridecyl isononanoate, diethoxyethyl succinate, and diisostearyl malate. Examples of the silicone oils include dimethicone, methylpolysiloxane, cyclopentasiloxane, cyclohexasiloxane, octamethylcyclotetrasiloxane, decamethylcyclopentasiloxane, dodecamethylcyclohexasiloxane, methylcyclopolysiloxane, tetrahydrotetramethylcyclotetrasiloxane, octamethyltrisiloxane, decamethyltetrasiloxane, methyl hydrogen polysiloxane, and methylphenylpolysiloxane. Examples of the hydrocarbons include liquid paraffin and isoparaffin.

When an oil-based solvent is incorporated, the content thereof is preferably not less than 0.1% by mass, more preferably not less than 0.2% by mass, with respect to a total mass of the aqueous component of the aerosol raw material composition contained in the freezing-type aerosol composition. When the content of the oil-based solvent is 0.1% by mass or more, the effects of incorporating the oil-based solvent are likely to be obtained. Further, the content of the oil-based solvent in the aqueous component of the aerosol raw material composition contained in the freezing-type aerosol composition is preferably 10.0% by mass or less, more preferably 5% by mass or less. When the content of the oil-based solvent is 10.0% by mass or less, the aerosol raw material composition contained in the freezing-type aerosol composition is likely to be emulsified, so that the sprayed composition is likely to freeze.

A powder, which is a particle (e.g., a powder body) to be dispersed in the aqueous component of the aerosol raw material composition contained in the freezing-type aerosol composition, is incorporated as appropriate for the purposes of promoting contact between the aqueous component of the aerosol raw material composition contained in the freezing-type aerosol composition and 1224yd to facilitate emulsification of the aqueous component of the aerosol raw material composition with 1224yd, and improving the usability by, for example, improving the smoothness at the time of applying and spreading a frozen product over an application spot and, when the application spot is the skin, absorbing sebum and making the skin smooth and dry. The powder is not particularly limited. Examples of the powder include talc, silica, kaolin, magnesium carbonate, calcium carbonate, zinc silicate, magnesium silicate, aluminum silicate, calcium silicate, zeolite, ceramic powder, carbon powder, nylon powder, silk powder, urethane powder, silicone powder, polyethylene powder, silica beads, glass beads, and resin beads.

When a powder is incorporated, the content thereof is preferably not less than 0.05% by mass, more preferably not less than 0.1% by mass, with respect to a total mass of the aqueous component of the aerosol raw material composition contained in the freezing-type aerosol composition. When the content of the powder is 0.05% by mass or more, the effects of incorporating the powder are likely to be obtained. Further, the content of the powder in the aqueous component of the aerosol raw material composition contained in the freezing-type aerosol composition is preferably 10.0% by mass or less, more preferably 5.0% by mass or less. When the content of the powder is 10.0% by mass or less, caking occurs in a container body during long-term storage of an aerosol product filled with the freezing-type aerosol composition in a stationary state, and this tends to make the freezing-type aerosol composition less likely to be dispersed even with shaking.

A preservative is preferably incorporated for improving the storage properties of the freezing-type aerosol composition.

The preservative is not particularly limited. Examples of the preservative include methylparaben (i.e. methyl p-hydroxybenzoate), ethylparaben (i.e. ethyl p-hydroxybenzoate), benzalkonium chloride, and o-cymen-5-ol (i.e. isopropylmethylphenol).

When a preservative is incorporated, the content thereof is not particularly limited. For example, the content of the preservative is preferably not less than 0.0001% by mass, more preferably not less than 0.001% by mass, with respect to a total mass of the aerosol raw material composition contained in the freezing-type aerosol composition. The content of the preservative is also preferably 1.0% by mass or less, more preferably 0.5% by mass or less, with respect to a total mass of the aerosol raw material composition contained in the freezing-type aerosol composition. When the content of the preservative is in this range, for example, deterioration and foul smell of an aerosol product caused by proliferation of microbes accidentally entering the aerosol product can be inhibited.

(Liquefied Gas)

As a liquefied gas, a hydrofluoroolefin (HFO) having a boiling point of from −30 to −5° C. is preferably incorporated. The HFO used as a liquefied gas is a liquid that has a vapor pressure in a container and is vaporized when sprayed, and it is preferably incorporated into the freezing-type aerosol composition for the purposes of, for example, cooling and freezing the aqueous component of the aerosol raw material composition contained in the freezing-type aerosol composition by the vaporization heat of the HFO.

The HFO incorporated as a liquefied gas is not particularly limited as long as it has a boiling point of from −30 to −5° C. For example, (E)-1,3,3,3-tetrafluoropropene (boiling point=−19° C., HFO-1234ze(E)) or 2,3,3,3-tetrafluoropropene (boiling point=−29° C., HFO-1234yf) is preferably used.

The content of the HFO incorporated as a liquefied gas is not particularly limited, and may be any amount as long as the timing of the vaporization of the HFO by 1224yd is appropriately adjusted. The content of the HFO incorporated as a liquefied gas in the freezing-type aerosol composition is preferably not less than 40.0% by mass, more preferably not less than 45.0% by mass. When the content of the HFO incorporated as a liquefied gas is 40.0% by mass or more, the aqueous component of the aerosol raw material composition contained in the freezing-type aerosol composition is likely to freeze. The content of the HFO incorporated as a liquefied gas in the freezing-type aerosol composition is also preferably 80.0% by mass or less, more preferably 70.0% by mass or less. When the content of the HFO incorporated as a liquefied gas is 80.0% by mass or less, the sprayed composition is unlikely to freeze at a spray nozzle or the like, so that a stable spray condition is likely to be obtained.

The freezing-type aerosol composition may also contain a liquefied gas other than HFO. The liquefied gas other than HFO is incorporated as appropriate for the purposes of, for example, adjusting the spraying force by reducing the pressure of the freezing-type aerosol composition, facilitating adhesion of the sprayed composition to an application spot, and adjusting the frozen state of a frozen product.

Examples of the liquefied gas other than HFO include a liquefied petroleum gas, dimethyl ether, and mixtures thereof. A hydrocarbon having 5 carbon atoms, such as isopentane or n-pentane, may be incorporated as well for the purposes of, for example, further reducing the pressure of the aerosol composition and making it easier to adjust the cooling effect.

When a liquefied gas other than HFO is incorporated, the content thereof is not particularly limited as long as the HFO incorporated as a liquefied gas is partially replaced as appropriate. The content of the liquefied gas other than HFO is preferably not less than 1.0% by mass, more preferably not less than 3.0% by mass, with respect to a total mass of the freezing-type aerosol composition. When the content of the liquefied gas other than HFO is 1.0% by mass or more, the effects of incorporating the liquefied gas are likely to be obtained. The content of the liquefied gas other than HFO is also preferably 20.0% by mass or less, more preferably 10.0% by mass or less, with respect to a total mass of the freezing-type aerosol composition. When the content of the liquefied gas other than HFO is 20.0% by mass or less, the flammability of the freezing-type aerosol composition is unlikely to be increased.

The freezing-type aerosol composition contains 1224yd and an HFO as a liquefied gas, and these are emulsified with the aqueous component of the aerosol raw material composition contained in the freezing-type aerosol composition. Thus, after the freezing-type aerosol composition is sprayed, the timing of the vaporization of 1224yd and the HFO contained as a liquefied gas is likely to be adjusted. As a result, the freezing-type aerosol composition is, for example, prevented from freezing before being sprayed from a spray nozzle, and thus unlikely to clog the spray nozzle. Accordingly, the spray condition is not disrupted, so that the freezing-type aerosol composition is appropriately sprayed to an application spot in a stable spray condition. In addition, since the timing of the vaporization of 1224yd and the HFO contained as a liquefied gas is adjusted, the freezing-type aerosol composition can form a frozen product after reaching and adhering to the application spot. Therefore, the freezing-type aerosol composition is more likely to adhere to the application spot without being scattered, as compared to a case where it freezes before reaching the application spot. Consequently, a stable frozen product is obtained at the application spot.

<Cooling-Type Aerosol Composition>

A cooling-type aerosol composition can persistently provide a moderate cooling sensation that is not overly strong.

(Water)

Water is incorporated for the purposes of, for example, adjusting the drying properties of the cooling-type aerosol composition and allowing a cooling effect to be maintained.

The content of water is preferably not less than 5.0% by mass, more preferably not less than 10.0% by mass, still more preferably not less than 15.0% by mass, with respect to a total amount of water and 1224yd. The content of water is also preferably 95.0% by mass or less, more preferably 90.0% by mass or less, still more preferably 85.0% by mass or less, with respect to a total amount of water and 1224yd.

When the content of water is in this range, a moderate cooling effect can be maintained over an extended period. In addition, separation is unlikely to occur, and a homogeneous phase is thus likely to be maintained.

(1224yd)

1224yd is incorporated for the purposes of, for example, providing a moderate cooling sensation that is not overly strong, adjusting the drying properties of the cooling-type aerosol composition, and inhibiting dripping at an application spot.

The content of 1224yd is preferably not less than 5.0% by mass, more preferably not less than 10.0% by mass, still more preferably not less than 15.0% by mass, with respect to a total amount of water and 1224yd. The content of 1224yd is also preferably 95.0% by mass or less, more preferably 90.0% by mass or less, still more preferably 85.0% by mass or less, with respect to a total amount of water and 1224yd.

When the content of 1224yd is in this range, a homogeneous phase is likely to be formed, and separation is unlikely to occur. In addition, the cooling-type aerosol composition is likely to provide a moderate cooling sensation and exhibits favorable drying properties at an application spot.

(Alcohol)

An alcohol is preferably incorporated for the purposes of, for example, allowing the aerosol raw material composition contained in the cooling-type aerosol composition to have a homogeneous composition.

The alcohol is not particularly limited. Examples of the alcohol include: monohydric alcohols having from 2 to 3 carbon atoms, such as ethanol and isopropanol; and polyhydric alcohols, such as propylene glycol, 1,3-butylene glycol, hexylene glycol, glycerol, dipropylene glycol, and diglycerol.

The content of the alcohol is not particularly limited. For example, the content of the alcohol is preferably not less than 25.0% by mass, more preferably not less than 35.0% by mass, with respect to a total mass of the aerosol raw material composition contained in the cooling-type aerosol composition. The content of the alcohol is also preferably 90.0% by mass or less, more preferably 80.0% by mass or less, with respect to a total mass of the aerosol raw material composition contained in the cooling-type aerosol composition.

(Optional Components)

The cooling-type aerosol composition may also contain optional components, such as an active ingredient, a surfactant, a water-soluble polymer, an oil agent, a powder, and a preservative, in addition to the above-described components.

Examples of the active ingredient include: various fragrances, such as natural fragrances and synthetic fragrances; refreshing agents, such as l-menthol, camphor, and mentha oil; vitamins, such as retinol, retinol acetate, retinol palmitate, calcium pantothenate, ascorbic acid magnesium phosphate, sodium ascorbate, dl-α-tocopherol, tocopherol acetate, tocopherol, tocopherol nicotinate, dibenzoyl thiamine, riboflavin, and mixtures thereof; antioxidants, such as ascorbic acid, α-tocopherol, dibutylhydroxytoluene, and butylhydroxyanisole; amino acids, such as glycine, alanine, leucine, serine, tryptophan, cysteine, methionine, aspartic acid, glutamic acid, and arginine; moisturizers, such as collagen, hyaluronic acid, charonic acid, sodium lactate, dl-pyrrolidone carboxylate, keratin, casein, lecithin, and urea; disinfectants, such as p-hydroxybenzoic acid esters, sodium benzoate, potassium sorbate, phenoxyethanol, benzalkonium chloride, benzethonium chloride, chlorhexidine chloride, and p-chloro-m-cresol; extracts, such as royal jelly extract, peony extract, Luffa cylindrica extract, rose extract, lemon extract, aloe extract, calamus root extract, Eucalyptus extract, sage extract, tea extract, seaweed extract, placenta extract, and silk extract; astringent agents, such as zinc oxide, allantoin hydroxyaluminum, tannic acid, citric acid, and lactic acid; anti-inflammatory agents, such as allantoin, glycyrrhetinic acid, dipotassium glycyrrhizate, and azulene; deodorants, such as lauryl methacrylate, methyl benzoate, methyl phenyl acetate, geranyl crotonate, acetophenone myristate, benzyl acetate, benzyl propionate, and green tea extract; ultraviolet absorbers, such as hexyl diethylaminohydroxybenzoyl benzoate, 2-ethylhexyl p-methoxycinnamate, ethylhexyl triazone, oxybenzone, hydroxybenzophenone sulfonic acid, sodium dihydroxybenzophenone sulfonate, and dihydroxybenzophenone; ultraviolet scattering agents, such as zinc oxide, titanium oxide, and octyltrimethoxysilane-coated titanium oxide; skin whitening agents, such as arbutin and kojic acid; pest repellents, such as N,N-diethyl-m-toluamide (DEET), di-n-butyl succinate, hydroxyanisole, rotenone, ethyl butylacetyl aminopropionate, icaridin (picaridin), p-menthane-3,8-diol, ethyl 3-[acetyl(butyl)amino]propionate, and 1-methylpropyl 2-(2-hydroxyethyl)piperidine-1-carboxylate; antiperspirants, such as chlorohydroxyaluminum and isopropylmethylphenol; and anti-inflammatory analgesic agents, such as methyl salicylate, indomethacin, felbinac, and ketoprofen.

When an active ingredient is incorporated, the content thereof is not particularly limited. For example, the content of the active ingredient is preferably not less than 0.1% by mass, more preferably not less than 0.3% by mass, with respect to a total mass of the aerosol raw material composition contained in the cooling-type aerosol composition. The content of the active ingredient is also preferably 20.0% by mass or less, more preferably 15.0% by mass or less, with respect to a total mass of the aerosol raw material composition contained in the cooling-type aerosol composition. When the content of the active ingredient is in this range, the effects of incorporating the active ingredient are likely to be obtained, and the cooling-type aerosol composition is unlikely to be separated.

A surfactant is preferably incorporated for obtaining an antistatic effect, a treatment effect, a cleaning effect, and the like.

The surfactant is not particularly limited, and any of the above-exemplified surfactants can be used.

The content of the surfactant is not particularly limited. For example, the content of the surfactant is preferably not less than 0.1% by mass, more preferably not less than 0.5% by mass, with respect to a total mass of the aerosol raw material composition contained in the cooling-type aerosol composition. The content of the surfactant is also preferably 20% by mass or less, more preferably 15% by mass or less, with respect to a total mass of the aerosol raw material composition contained in the cooling-type aerosol composition. When the content of the surfactant is in this range, the cooling-type aerosol composition is likely to exert a desired effect, and has favorable usability without stickiness.

A water-soluble polymer is preferably incorporated for the purposes of, for example, increasing the particle size of the cooling-type aerosol composition to be sprayed so as to prevent the user from inhaling the sprayed particles, facilitating adhesion of the sprayed composition to an application spot, and adjusting the persistence of a cooling sensation.

The water-soluble polymer is not particularly limited, and any of the above-exemplified water-soluble polymers can be used. Examples of the water-soluble polymer include: cellulose-based polymers, such as hydroxymethyl cellulose, hydroxyethyl cellulose, hydroxypropyl cellulose, hydroxypropyl methylcellulose, sodium carboxymethyl cellulose, and cellulose nanofibers; gum substances, such as xanthan gum, carrageenan, gum arabic, gum tragacanth, cationized guar gum, guar gum, and gellan gum; dextran; sodium carboxymethyl dextran; dextrin; pectin; sodium alginate; sodium hyaluronate; polyvinyl alcohols; and carboxyvinyl polymers.

When a water-soluble polymer is incorporated, the content thereof is not particularly limited. For example, the content of the water-soluble polymer is preferably not less than by mass, more preferably not less than 0.03% by mass, with respect to a total mass of the aerosol raw material composition contained in the cooling-type aerosol composition. The content of the water-soluble polymer is also preferably 5.0% by mass or less, more preferably 3.0% by mass or less, with respect to a total mass of the aerosol raw material composition contained in the cooling-type aerosol composition. When the content of the water-soluble polymer is in this range, the effects of incorporating the water-soluble polymer are likely to be obtained, and the viscosity of the aerosol raw material composition contained in the cooling-type aerosol composition is not excessively high, so that the cooling-type aerosol composition can be easily sprayed.

An oil agent is preferably incorporated for the purposes of, for example, softening the touch to the skin of the sprayed cooling-type aerosol composition and improving the combability.

The oil agent is not particularly limited. Examples of the oil agent include: silicone oils, such as dimethicone, methylpolysiloxane, cyclopentasiloxane, cyclohexasiloxane, octamethylcyclotetrasiloxane, decamethylcyclopentasiloxane, dodecamethylcyclohexasiloxane, methylcyclopolysiloxane, tetrahydrotetramethylcyclotetrasiloxane, octamethyltrisiloxane, decamethyltetrasiloxane, methyl hydrogen polysiloxane, and methylphenylpolysiloxane; hydrocarbon oils, such as liquid paraffin and isoparaffin; ester oils, such as methylpentanediol dineopentanoate, diethylpentanediol dineopentanoate, neopentyl glycol di-2-ethyl hexanoate, neopentyl glycol dicaprate, propylene glycol dilaurate, ethylene glycol distearate, diethylene glycol dilaurate, diethylene glycol distearate, diethylene glycol diisostearate, diethylene glycol dioleate, triethylene glycol dilaurate, triethylene glycol distearate, triethylene glycol diisostearate, triethylene glycol dioleate, propylene glycol monostearate, propylene glycol monooleate, ethylene glycol monostearate, glyceryl tri-2-ethyl hexanoate, tri(caprylic/capric acid) glycerin, isononyl isononanoate, isotridecyl isononanoate, diethoxyethyl succinate, diisostearyl malate, isopropyl myristate, isopropyl palmitate, cetyl isooctanoate, octyl hydroxystearate, and ethylhexyl hydroxystearate; fatty oils, such as olive oil, camellia oil, corn oil, castor oil, safflower oil, jojoba oil, and coconut oil; fatty acids, such as isostearic acid and oleic acid; and higher alcohols, such as oleyl alcohol and isostearyl alcohol.

When an oil agent is incorporated, the content thereof is not particularly limited. For example, the content of the oil agent is preferably not less than 0.1% by mass, more preferably not less than 0.5% by mass, with respect to a total mass of the aerosol raw material composition contained in the cooling-type aerosol composition. The content of the oil agent is also preferably 20.0% by mass or less, more preferably 10.0% by mass or less, with respect to a total mass of the aerosol raw material composition contained in the cooling-type aerosol composition. When the content of the oil agent is in this range, the effects of incorporating the oil agent are likely to be obtained. In addition, the drying properties of the cooling-type aerosol composition are unlikely to be deteriorated, and the cooling-type aerosol composition is unlikely to cause stickiness.

A powder is preferably incorporated for improving the usability by, for example, providing a silky feel.

The powder is not particularly limited. Examples of the powder include talc, zinc oxide, titanium oxide, silica, zeolite, kaolin, mica, magnesium carbonate, calcium carbonate, zinc silicate, magnesium silicate, aluminum silicate, and calcium silicate. When a powder is incorporated, the content thereof is not particularly limited. For example, the content of the powder is preferably not less than 0.1% by mass, more preferably not less than 0.3% by mass, with respect to a total mass of the aerosol raw material composition contained in the cooling-type aerosol composition. The content of the powder is also preferably 5.0% by mass or less, more preferably 3.0% by mass or less, with respect to a total mass of the aerosol raw material composition contained in the cooling-type aerosol composition. When the content of the powder is in this range, the effects of incorporating the powder are likely to be obtained, and the cooling-type aerosol composition is unlikely to cause clogging in a discharge passage when discharged.

A preservative is preferably incorporated for improving the storage properties of the cooling-type aerosol composition.

The preservative is not particularly limited. Examples of the preservative include methylparaben (i.e. methyl p-hydroxybenzoate), ethylparaben (i.e. ethyl p-hydroxybenzoate), benzalkonium chloride, and o-cymen-5-ol (i.e. isopropylmethylphenol).

When a preservative is incorporated, the content thereof is not particularly limited. For example, the content of the preservative is preferably not less than 0.0001% by mass, more preferably not less than 0.001% by mass, with respect to a total mass of the aerosol raw material composition contained in the cooling-type aerosol composition. The content of the preservative is also preferably 1.0% by mass or less, more preferably 0.5% by mass or less, with respect to a total mass of the aerosol raw material composition contained in the cooling-type aerosol composition. When the content of the preservative is in this range, for example, deterioration and foul smell of an aerosol product caused by proliferation of microbes accidentally entering the aerosol product can be inhibited.

(Compressed Gas)

A compressed gas is preferably incorporated as a propellant that pressurizes and discharges the aerosol raw material composition contained in the cooling-type aerosol composition to the outside.

The cooling-type aerosol composition preferably contains the above-described compressed gas as a propellant, but not a liquefied gas such as a liquefied petroleum gas. In the cooling-type aerosol composition, even when a liquefied gas such as a liquefied petroleum gas (e.g., one having a pressure of higher than 0.2 MPa at 35° C.) is not used in this manner, the above-described water, alcohol, and a hydrofluoroolefin are incorporated to form a homogeneous phase, so that the cooling-type aerosol composition is likely to be volatilized after being sprayed and thereby adhered to the skin or the like, and can impart the application spot with a moderate cooling sensation that is not overly strong.

The compressed gas is filled into a container body such that the pressure inside the container body at 25° C. is preferably 0.2 MPa or higher, more preferably 0.3 MPa or higher. Further, the compressed gas is filled into the container body such that the pressure inside the container body at 25° C. is preferably 0.8 MPa or lower, more preferably 0.7 MPa or lower. When the compressed gas is filled such that the pressure is in this range, the cooling-type aerosol composition is likely to be sprayed in an appropriate amount.

The cooling-type aerosol composition can exert an excellent cooling effect even when a liquefied gas (e.g., one having a pressure of higher than 0.2 MPa at 35° C.) is not used therein. In addition, the cooling-type aerosol composition has excellent safety, exhibiting only a small increase in the pressure associated with an increase in the temperature.

<<Aerosol Product>>

The aerosol product of the disclosure includes: a container body; and the aerosol composition of the disclosure, which is stored inside the container body.

(Container Body)

The container body is a container into which the aerosol composition is filled. The container body is a pressure-resistant container which has a bottomed cylindrical shape with an opening at the top. The opening is a filling port for filling the aerosol composition, and it is closed by the below-described valve mechanism.

The material of the container body is not particularly limited. Examples thereof include: metals such as aluminum and tin; various synthetic resins such as polyethylene terephthalate; and pressure-resistant glass.

It is noted here that it is desirable to keep in mind that the aerosol raw material composition contained in the aerosol composition of the disclosure contains water. When the inner surface of the container body coming into contact with the aerosol raw material composition is made of a material such as iron that is corroded by water, there is a risk that the container body is corroded by the water contained in the aerosol raw material composition. Therefore, when the container body is made of a material such as iron that is corroded by water, the inner surface coming into contact with the aerosol raw material composition is preferably coated with a synthetic resin by a method such as spray coating or powder coating. Examples of the synthetic resin used for coating the inner surface of the container body include polyolefin-based, epoxy-amino-based, epoxy phenol-based, polyamide-based, polyamide imide-based, polyvinyl chloride-based, vinyl-based, and organosol-based synthetic resins.

The container body may have a double structure which includes an outer container having excellent pressure resistance, and an inner container provided inside the outer container. The material of the outer container is not particularly limited as long as it has excellent pressure resistance. Examples of such a material include: metals such as aluminum and tin; various synthetic resins such as polyethylene terephthalate; and pressure-resistant glass. The inner container is provided for preventing contact between the aerosol raw material composition and the inner peripheral surface of the outer container. By this, corrosion of the outer container by the water contained in the aerosol raw material composition is inhibited. The material of the inner container is selected from those materials that are hardly corroded by the water contained in the aerosol raw material composition. Examples of such materials include synthetic resins such as polyethylenes, polypropylenes, and ethylene-vinyl alcohol copolymers, and the inner container may have a single-layer structure of any of these materials, or a layered structure such as polyethylene/ethylene-vinyl alcohol copolymer/polyethylene.

(Valve Mechanism)

The valve mechanism is a member for closing and tightly sealing the opening of the container body. The valve mechanism mainly includes: a housing; a stem on which a stem orifice communicating the inside and the outside of the container body is formed; and a stem gasket which is attached to the circumference of the stem orifice and used for closing the stem orifice. The housing accommodates the stem. The stem is a substantially cylindrical part, and a stem inner passage which the aerosol composition taken into the housing passes through at the time of discharge is formed. In the vicinity of a lower end of the stem inner passage, the stem orifice communicating the interior space of the housing and the stem inner passage is formed. A discharge member for discharging the aerosol composition is attached to an upper end of the stem. The stem gasket is a member which is attached to the circumference of the stem orifice and used for blocking the interior space of the housing from the outside as appropriate. The stem gasket is a disk-shaped member and, during a non-discharge period, its inner peripheral surface is tightly adhered to the outer peripheral surface of the stem on which the stem orifice is formed, whereby the stem orifice is closed.

The stem orifice has a diameter of preferably from 0.2 mm to 0.7 mm, more preferably from 0.3 mm to 0.6 mm.

(Discharge Member)

The discharge member is a member for discharging the aerosol composition, and it is attached to the upper end of the stem. The discharge member mainly includes: a nozzle part; and an actuator part which is operated by the user with a finger or the like. The nozzle part is a substantially cylindrical part, and a discharge passage which the aerosol composition passes through is formed. At the tip of the discharge passage, an opening (i.e. a discharge orifice) is formed. The aerosol composition is discharged from this discharge orifice. The discharge orifice is not particularly limited in terms of the number and the shape thereof. The discharge orifice may be provided in a plural number. Further, the shape of the discharge orifice may be, for example, a substantially circular shape or a substantially angular shape.

The discharge orifice has a diameter of preferably from 0.5 mm to 3.0 mm, more preferably from 0.6 mm to 2.0 mm.

The discharge member may be configured such that a spray tube can be attached to the nozzle part for the purpose of modifying the particle state of the aerosol composition. In order not to disrupt the spraying of the aerosol composition, the spray tube has an inner diameter of preferably from 0.3 to 3.0 mm, more preferably from 0.5 to 1.5 mm.

In the aerosol product according to one embodiment of the invention, the stem of the valve mechanism is pushed downward when the discharge member is pressed down. This causes the stem gasket to be bent downward, and the stem orifice is opened. As a result, the inside of the container body is communicated with the outside. Once the inside of the container body and the outside are communicated, the pressure of the compressed gas existing mainly in the gas-phase portion of the container body presses the liquid surface of the aerosol raw material composition contained in the aerosol composition. By this, the aerosol raw material composition contained in the aerosol composition is taken into the housing, subsequently sent to the discharge member through the stem orifice and the stem inner passage, and then discharged from the discharge orifice.

It is noted here that the discharge orifice of the discharge member corresponds to the spray nozzle of the aerosol product in the above-described flame generation condition test.

### EXAMPLES

Embodiments of the invention will now be described in more detail by way of Examples thereof; however, the invention is not limited thereto.

(Flammability Test of Aerosol Raw Material Compositions—Flame Propagation Angle)

The flammability was evaluated for each of the compositions containing 1224yd(Z) or 1224yd(E) and water, and compositions containing 1233zd(E), which is described as a preferred example of HFO in the aerosol composition disclosed in Patent Document 2, and water.

The evaluation of the flammability was carried out using the measuring device prescribed in ASTM E681-09. A round flask having an internal capacity of 12 L, which had been controlled at a temperature of 27° C. ±1° C., was evacuated, and each composition and dry air were subsequently added thereto until the pressure inside the flask reached 101.3 kPa ±0.7 kPa. The composition was stirred with a magnetic stirrer, and then spark-ignited at 15 kV and 30 mA for 0.4 seconds using electrodes arranged at a height of one-third from the bottom of the flask, after which the angle of upward spread of a flame from the ignition source (i.e. flame propagation angle) was checked.

The complete combustion theoretical mixing ratio with respect to dry air is 8.5% by volume for 1224yd(Z) and 1224yd(E), and 7.1% by volume for 1233zd(E).

The amount of water was set in three ways: an amount equivalent to a relative humidity of 50% at 23° C. (0.0088 g (water)/g (air) in terms of absolute humidity); an amount equivalent to a relative humidity of 100% at 23° C. and a relative humidity of 80% at 27° C. (0.0176 g (water)/g (air) in terms of absolute humidity); and an amount equivalent to a relative humidity of 100% at 27° C. (0.022 g (water)/g (air) in terms of absolute humidity).

Tables 1 and 2 show the cases where the amount of water was equivalent to a relative humidity of 50% at 23° C. (0.0088 g (water)/g (air) in terms of absolute humidity). Tables 3 to 5 show the cases where the amount of water was equivalent to a relative humidity of 100% at 23° C. and a relative humidity of 80% at 27° C. (0.0176 g (water)/g (air) in terms of absolute humidity). Tables 6 to 8 show the cases where the amount of water was equivalent to a relative humidity of 100% at 27° C. (0.022 g (water)/g (air) in terms of absolute humidity).

In Tables 1 to 8 below, the first four columns from the left indicate the volume ratios of 1224yd(Z), 1224yd(E), or 1233zd(E), water, and air; the 5th to the 7th columns from the left indicate the amount in % by mass of 1224yd(Z), 1224yd(E), or 1233zd(E), and that of water with respect to a total amount of 1224yd(Z), 1224yd(E), or 1233zd(E), and water in the respective conditions.

TABLE 1

| | | | | | | | Flame |
|---|---|---|---|---|---|---|---|
| | | | | | | | propagation |
| 1224yd(Z) | Water | Air | Total | 1224yd(Z) | Water | Total | angle |
| % by volume | % by volume | % by volume | % by volume | % by weight | % by weight | % by weight | (°) |
| 1.0 | 1.4 | 97.6 | 100.0 | 85.7 | 14.3 | 100.0 | 0 |
| 2.0 | 1.4 | 96.6 | 100.0 | 92.4 | 7.6 | 100.0 | 0 |
| 3.0 | 1.3 | 95.7 | 100.0 | 94.8 | 5.2 | 100.0 | 0 |
| 4.0 | 1.3 | 94.7 | 100.0 | 96.1 | 3.9 | 100.0 | 0 |
| 5.0 | 1.3 | 93.7 | 100.0 | 96.9 | 3.1 | 100.0 | 0 |
| 6.0 | 1.3 | 92.7 | 100.0 | 97.4 | 2.6 | 100.0 | 0 |
| 7.0 | 1.3 | 91.7 | 100.0 | 97.8 | 2.2 | 100.0 | 0 |
| 8.0 | 1.3 | 90.7 | 100.0 | 98.1 | 1.9 | 100.0 | 0 |
| 8.5 | 1.3 | 90.2 | 100.0 | 98.2 | 1.8 | 100.0 | 0 |
| 9.0 | 1.3 | 89.7 | 100.0 | 98.3 | 1.7 | 100.0 | 0 |
| 10.0 | 1.3 | 88.7 | 100.0 | 98.5 | 1.5 | 100.0 | 0 |
| 11.0 | 1.2 | 87.8 | 100.0 | 98.7 | 1.3 | 100.0 | 0 |
| 12.0 | 1.2 | 86.8 | 100.0 | 98.8 | 1.2 | 100.0 | 0 |
| 13.0 | 1.2 | 85.8 | 100.0 | 98.9 | 1.1 | 100.0 | 0 |
| 14.0 | 1.2 | 84.8 | 100.0 | 99.0 | 1.0 | 100.0 | 0 |

TABLE 2

| | | | | | | | Flame |
|---|---|---|---|---|---|---|---|
| | | | | | | | propagation |
| 1224yd(E) | Water | Air | Total | 1224yd(E) | Water | Total | angle |
| % by volume | % by volume | % by volume | % by volume | % by weight | % by weight | % by weight | (°) |
| 1 | 1.4 | 97.6 | 100.0 | 85.7 | 14.3 | 100.0 | 0 |
| 2 | 1.4 | 96.6 | 100.0 | 92.4 | 7.6 | 100.0 | 0 |
| 3 | 1.3 | 95.7 | 100.0 | 94.8 | 5.2 | 100.0 | 0 |
| 4 | 1.3 | 94.7 | 100.0 | 96.1 | 3.9 | 100.0 | 0 |
| 5 | 1.3 | 93.7 | 100.0 | 96.9 | 3.1 | 100.0 | 0 |
| 6.0 | 1.3 | 92.7 | 100.0 | 97.4 | 2.6 | 100.0 | 0 |
| 7.0 | 1.3 | 91.7 | 100.0 | 97.8 | 2.2 | 100.0 | 0 |
| 8.0 | 1.2 | 90.8 | 100.0 | 98.1 | 1.9 | 100.0 | 0 |
| 8.5 | 1.3 | 90.2 | 100.0 | 98.2 | 1.8 | 100.0 | 0 |
| 9.0 | 1.3 | 89.7 | 100.0 | 98.3 | 1.7 | 100.0 | 0 |
| 10.0 | 1.3 | 88.7 | 100.0 | 98.5 | 1.5 | 100.0 | 0 |
| 11.1 | 1.3 | 87.6 | 100.0 | 98.6 | 1.4 | 100.0 | 0 |
| 12.0 | 1.3 | 86.7 | 100.0 | 98.7 | 1.3 | 100.0 | 0 |
| 13.0 | 1.2 | 85.8 | 100.0 | 98.9 | 1.1 | 100.0 | 0 |
| 14.0 | 1.2 | 84.8 | 100.0 | 99.0 | 1.0 | 100.0 | 0 |

TABLE 3

| | | | | | | | Flame |
|---|---|---|---|---|---|---|---|
| | | | | | | | propagation |
| 1224yd(Z) | Water | Air | Total | 1224yd(Z) | Water | Total | angle |
| % by volume | % by volume | % by volume | % by volume | % by weight | % by weight | % by weight | (°) |
| 1.0 | 2.7 | 96.3 | 100.0 | 75.2 | 24.8 | 100.0 | 0 |
| 2.0 | 2.7 | 95.3 | 100.0 | 86.0 | 14.0 | 100.0 | 0 |
| 3.0 | 2.7 | 94.3 | 100.0 | 90.3 | 9.7 | 100.0 | 0 |
| 4.0 | 2.6 | 93.4 | 100.0 | 92.6 | 7.4 | 100.0 | 0 |
| 5.0 | 2.6 | 92.4 | 100.0 | 94.1 | 5.9 | 100.0 | 0 |
| 6.0 | 2.6 | 91.4 | 100.0 | 95.0 | 5.0 | 100.0 | 0 |
| 7.0 | 2.6 | 90.4 | 100.0 | 95.8 | 4.2 | 100.0 | 0 |
| 8.0 | 2.5 | 89.5 | 100.0 | 96.3 | 3.7 | 100.0 | 0 |
| 8.5 | 2.5 | 89.0 | 100.0 | 96.5 | 3.5 | 100.0 | 0 |
| 9.0 | 2.5 | 88.5 | 100.0 | 96.7 | 3.3 | 100.0 | 0 |
| 10.0 | 2.5 | 87.5 | 100.0 | 97.1 | 2.9 | 100.0 | 0 |
| 11.0 | 2.4 | 86.6 | 100.0 | 97.4 | 2.6 | 100.0 | 0 |
| 12.0 | 2.4 | 85.6 | 100.0 | 97.6 | 2.4 | 100.0 | 0 |
| 13.0 | 2.4 | 84.6 | 100.0 | 97.8 | 2.2 | 100.0 | 0 |
| 14.0 | 2.4 | 83.6 | 100.0 | 98.0 | 2.0 | 100.0 | 0 |
| 15.0 | 2.3 | 82.7 | 100.0 | 98.1 | 1.9 | 100.0 | 0 |
| 16.0 | 2.3 | 81.7 | 100.0 | 98.3 | 1.7 | 100.0 | 0 |
| 17.0 | 2.3 | 80.7 | 100.0 | 98.4 | 1.6 | 100.0 | 0 |
| 18.0 | 2.2 | 79.8 | 100.0 | 98.5 | 1.5 | 100.0 | 0 |
| 19.0 | 2.2 | 78.8 | 100.0 | 98.6 | 1.4 | 100.0 | 0 |
| 20.0 | 2.2 | 77.8 | 100.0 | 98.7 | 1.3 | 100.0 | 0 |

TABLE 4

| | | | | | | | Flame |
|---|---|---|---|---|---|---|---|
| | | | | | | | propagation |
| 1224yd(E) | Water | Air | Total | 1224yd(E) | Water | Total | angle |
| % by volume | % by volume | % by volume | % by volume | % by weight | % by weight | % by weight | (°) |
| 1.0 | 2.7 | 96.3 | 100.0 | 75.2 | 24.8 | 100.0 | 0 |
| 2.0 | 2.7 | 95.3 | 100.0 | 86.0 | 14.0 | 100.0 | 0 |
| 3.0 | 2.7 | 94.3 | 100.0 | 90.3 | 9.7 | 100.0 | 0 |
| 4.0 | 2.6 | 93.4 | 100.0 | 92.6 | 7.4 | 100.0 | 0 |
| 5.0 | 2.6 | 92.4 | 100.0 | 94.1 | 5.9 | 100.0 | 0 |
| 6.0 | 2.6 | 91.4 | 100.0 | 95.0 | 5.0 | 100.0 | 0 |
| 7.0 | 2.6 | 90.4 | 100.0 | 95.8 | 4.2 | 100.0 | 0 |
| 8.0 | 2.5 | 89.5 | 100.0 | 96.3 | 3.7 | 100.0 | 0 |
| 8.5 | 2.5 | 89.0 | 100.0 | 96.5 | 3.5 | 100.0 | 0 |
| 9.0 | 2.5 | 88.5 | 100.0 | 96.7 | 3.3 | 100.0 | 0 |
| 10.0 | 2.5 | 87.5 | 100.0 | 97.1 | 2.9 | 100.0 | 0 |
| 11.0 | 2.4 | 86.6 | 100.0 | 97.4 | 2.6 | 100.0 | 0 |
| 12.0 | 2.4 | 85.6 | 100.0 | 97.6 | 2.4 | 100.0 | 0 |
| 13.0 | 2.4 | 84.6 | 100.0 | 97.8 | 2.2 | 100.0 | 0 |
| 14.0 | 2.4 | 83.6 | 100.0 | 98.0 | 2.0 | 100.0 | 0 |
| 15.0 | 2.3 | 82.7 | 100.0 | 98.1 | 1.9 | 100.0 | 0 |
| 16.0 | 2.3 | 81.7 | 100.0 | 98.3 | 1.7 | 100.0 | 0 |
| 17.0 | 2.3 | 80.7 | 100.0 | 98.4 | 1.6 | 100.0 | 0 |
| 18.0 | 2.2 | 79.8 | 100.0 | 98.5 | 1.5 | 100.0 | 0 |
| 19.0 | 2.2 | 78.8 | 100.0 | 98.6 | 1.4 | 100.0 | 0 |
| 20.0 | 2.2 | 77.8 | 100.0 | 98.7 | 1.3 | 100.0 | 0 |

TABLE 5

| | | | | | | | Flame |
|---|---|---|---|---|---|---|---|
| | | | | | | | propagation |
| 1233zd(E) | Water | Air | Total | 1233zd(E) | Water | Total | angle |
| % by volume | % by volume | % by volume | % by volume | % by weight | % by weight | % by weight | (°) |
| 7.1 | 2.4 | 90.5 | 100.0 | 95.5 | 4.5 | 100.0 | 34 |
| 8.0 | 2.5 | 89.5 | 100.0 | 95.9 | 4.1 | 100.0 | 70 |

TABLE 6

| | | | | | | | Flame |
|---|---|---|---|---|---|---|---|
| | | | | | | | propagation |
| 1224yd(Z) | Water | Air | Total | 1224yd(Z) | Water | Total | angle |
| % by volume | % by volume | % by volume | % by volume | % by weight | % by weight | % by weight | (°) |
| 1.0 | 3.4 | 95.6 | 100.0 | 71.0 | 29.0 | 100.0 | 0 |
| 2.0 | 3.3 | 94.7 | 100.0 | 83.2 | 16.8 | 100.0 | 0 |
| 3.0 | 3.3 | 93.7 | 100.0 | 88.2 | 11.8 | 100.0 | 0 |
| 4.0 | 3.3 | 92.7 | 100.0 | 91.0 | 9.0 | 100.0 | 0 |
| 5.0 | 2.8 | 92.2 | 100.0 | 93.6 | 6.4 | 100.0 | 0 |
| 6.0 | 2.7 | 91.3 | 100.0 | 94.9 | 5.1 | 100.0 | 0 |
| 7.1 | 3.0 | 90.0 | 100.0 | 95.2 | 4.8 | 100.0 | 0 |
| 8.5 | 2.8 | 88.7 | 100.0 | 96.1 | 3.9 | 100.0 | 0 |
| 9.0 | 2.8 | 88.2 | 100.0 | 96.4 | 3.6 | 100.0 | 0 |
| 10.0 | 2.7 | 87.3 | 100.0 | 96.8 | 3.2 | 100.0 | 0 |
| 11.0 | 2.7 | 86.3 | 100.0 | 97.1 | 2.9 | 100.0 | 0 |
| 12.0 | 2.6 | 85.4 | 100.0 | 97.4 | 2.6 | 100.0 | 0 |
| 13.0 | 2.6 | 84.4 | 100.0 | 97.6 | 2.4 | 100.0 | 0 |
| 14.0 | 2.6 | 83.4 | 100.0 | 97.8 | 2.2 | 100.0 | 0 |
| 15.0 | 2.5 | 82.5 | 100.0 | 98.0 | 2.0 | 100.0 | 0 |
| 16.0 | 2.5 | 81.5 | 100.0 | 98.2 | 1.8 | 100.0 | 0 |
| 17.0 | 2.4 | 80.6 | 100.0 | 98.3 | 1.7 | 100.0 | 0 |
| 18.0 | 2.4 | 79.6 | 100.0 | 98.4 | 1.6 | 100.0 | 0 |
| 19.0 | 2.8 | 78.2 | 100.0 | 98.3 | 1.7 | 100.0 | 0 |
| 20.0 | 2.7 | 77.3 | 100.0 | 98.4 | 1.6 | 100.0 | 0 |

TABLE 7

| | | | | | | | Flame |
|---|---|---|---|---|---|---|---|
| | | | | | | | propagation |
| 1224yd(E) | Water | Air | Total | 1224yd(E) | Water | Total | angle |
| % by volume | % by volume | % by volume | % by volume | % by weight | % by weight | % by weight | (°) |
| 1.0 | 3.4 | 95.6 | 100.0 | 71.0 | 29.0 | 100.0 | 0 |
| 2.0 | 3.3 | 94.7 | 100.0 | 83.2 | 16.8 | 100.0 | 0 |
| 3.0 | 3.3 | 93.7 | 100.0 | 88.2 | 11.8 | 100.0 | 0 |
| 4.0 | 3.3 | 92.7 | 100.0 | 91.0 | 9.0 | 100.0 | 0 |
| 5.0 | 3.1 | 92.0 | 100.0 | 93.1 | 6.9 | 100.0 | 0 |
| 6.0 | 3.0 | 91.0 | 100.0 | 94.3 | 5.7 | 100.0 | 0 |
| 7.0 | 2.8 | 90.2 | 100.0 | 95.4 | 4.6 | 100.0 | 0 |
| 8.0 | 2.9 | 89.1 | 100.0 | 95.7 | 4.3 | 100.0 | 0 |
| 8.5 | 2.8 | 88.7 | 100.0 | 96.1 | 3.9 | 100.0 | 0 |
| 9.0 | 3.0 | 88.0 | 100.0 | 96.2 | 3.8 | 100.0 | 0 |
| 10.0 | 2.9 | 87.1 | 100.0 | 96.6 | 3.4 | 100.0 | 0 |
| 11.0 | 2.9 | 86.1 | 100.0 | 96.9 | 3.1 | 100.0 | 0 |
| 12.0 | 2.9 | 85.1 | 100.0 | 97.2 | 2.8 | 100.0 | 0 |
| 13.0 | 2.8 | 84.2 | 100.0 | 97.4 | 2.6 | 100.0 | 0 |
| 14.0 | 2.9 | 83.1 | 100.0 | 97.5 | 2.5 | 100.0 | 0 |
| 15.0 | 2.9 | 82.1 | 100.0 | 97.7 | 2.3 | 100.0 | 0 |
| 16.0 | 2.9 | 81.1 | 100.0 | 97.9 | 2.1 | 100.0 | 0 |
| 17.0 | 2.8 | 80.2 | 100.0 | 98.0 | 2.0 | 100.0 | 0 |
| 18.0 | 2.8 | 79.2 | 100.0 | 98.2 | 1.8 | 100.0 | 0 |
| 19.0 | 2.8 | 78.2 | 100.0 | 98.3 | 1.7 | 100.0 | 0 |
| 20.0 | 2.7 | 77.3 | 100.0 | 98.4 | 1.6 | 100.0 | 0 |

TABLE 8

| | | | | | | | Flame |
|---|---|---|---|---|---|---|---|
| | | | | | | | propagation |
| 1233zd(E) | Water | Air | Total | 1233zd(E) | Water | Total | angle |
| % by volume | % by volume | % by volume | % by volume | % by weight | % by weight | % by weight | (°) |
| 7.1 | 2.8 | 90.1 | 100.0 | 94.8 | 5.2 | 100.0 | 40.0 |
| 8.0 | 3.1 | 88.9 | 100.0 | 95.0 | 5.0 | 100.0 | 82.0 |

As shown in Tables 5 and 8, in those cases of a high moisture content in the air such as when the amount of water was equivalent to a relative humidity of 100% at 23° C. and a relative humidity of 80% at 27° C. and when the amount of water was equivalent to a relative humidity of 1% at 27° C., the compositions containing 1233zd(E) and water had an increase in the flame propagation angle at about the complete combustion theoretical mixing ratio of 1233zd(E) with respect to dry air of 7.1% by volume.

On the other hand, as shown in Tables 1 to 4, 6, and 7, the compositions containing 1224yd(Z) or 1224yd(E) and water all had a flame propagation angle of 0° at about the complete combustion theoretical mixing ratio with respect to dry air of 8.5% by volume, even in those cases of a high moisture content in the air.

(Flammability Test of Aerosol Products—Effect of Water Content on Flame Length)

As shown in Table 9, compositions containing 1224yd(Z) and water and compositions containing 1233zd(E), which is described as a preferred example of HFO in the aerosol composition disclosed in Patent Document 2, and water were mixed such that the water concentration was 1.0% by mass or 5.0% by mass with respect to a total amount of water and 1224yd(Z) or 1233zd(E), and then each filled into a tin spray container. Subsequently, as a compressed gas, carbon dioxide or nitrogen was filled into the body of the spray container, and the pressure inside the container was adjusted to be 0.6 MPa (25° C.), whereby aerosol products were produced.

It is noted here that, as the tin spray container, one which included a container body, a valve mechanism having a stem orifice diameter of 0.45 mm, a discharge member having a discharge orifice diameter of 0.6 mm, and a spray tube having an inner diameter of 1.0 mm was used.

Using the thus produced aerosol products, the flammability of each of the aerosol products was evaluated by the following evaluation method.

The flammability was evaluated in accordance with the procedure prescribed in JIS S3301(2018) 6.5 Flame Generation Condition Test, except for the distance from a flame burner to the spray nozzle of each aerosol product in the below-described measurement of the flame length. Each aerosol product was immersed for at least 30 minutes in a thermostat water bath controlled at 25° C. ±0.5° C. to adjust the aerosol composition in the aerosol product to have a constant temperature. A flame burner was controlled to have a flame vertical length of from 4.5 cm to 5.5 cm, and the height of the spray nozzle of the aerosol product was adjusted such that, in a favorable spray condition (i.e. spray pattern), the aerosol composition contained in the aerosol product would pass through an upper one-third of the flame of the flame burner.

The measurement of the flame length was carried out by spraying the aerosol product to the flame at a distance of 5 cm from the flame to the spray nozzle. Specifically, the horizontal length L1 of the upper one-third of the flame was measured when the aerosol composition was sprayed, and the horizontal length L2 of the upper one-third of the flame was measured when the aerosol composition was not sprayed. Specifically, the behavior of the flame during the flame generation condition test was video-recorded with a scaled stand being placed on the back, and the thus recorded image was analyzed. A difference between L1 and L2 (L1−L2) was defined as the flame length of the aerosol composition, which is the sprayed content.

The effect of the water content on the flame length was evaluated as follows.

Based on the flame length of an aerosol composition having a water concentration of 1.0% by mass with respect to a total amount of water and 1224yd(Z) or 1233zd(E), whether the flame length of an aerosol composition having a water concentration of 5.0% by mass was increased or not, and the amount of increase if any, were checked and evaluated in accordance with the following evaluation criteria. The results thereof are shown in Table 9.

(Evaluation Criteria for Effect of Water Content on Flame Length)
AA: No change in flame length

A: Change in flame length=less than +3 cm

B: Change in flame length=+3 cm or more

TABLE 9

| Aerosol composition | | | | Effect of water | |
|---|---|---|---|---|---|
| Aerosol raw material composition | | | | content on flame | |
| 1224yd(Z) | 1233zd(E) | Water | | length | |
| % by | % by | % by | Compressed gas | | Evalu- |
| weight | weight | weight | — | cm | ation |
| 99.0 | | 1.0 | carbon dioxide | 0 | AA |
| 95.0 | | 5.0 | carbon dioxide | | |
| 99.0 | | 1.0 | nitrogen | 0 | AA |
| 95.0 | | 5.0 | nitrogen | | |
| | 99.0 | 1.0 | carbon dioxide | +2 | A |
| | 95.0 | 5.0 | carbon dioxide | | |

As shown in Table 9, with regard to the compositions containing 1233zd(E) and water, the flame length was increased, and the flame was enlarged when the water concentration was increased from 1.0% by mass to 5.0% by mass.

On the other hand, with regard to the compositions containing 1224yd(Z) and water, even when the water concentration was increased from 1.0% by mass to 5.0% by mass, the change in the water concentration did not lead to an increase in the flame length. Based on these results, according to one embodiment of the invention, an aerosol raw material composition, an aerosol composition, and an aerosol product, in which a propellant has a low flammability even at an increased water concentration when discharged from a container such as a spray can, can be provided.

It is noted here that the aerosol compositions shown in Table 9, which contained 1224yd(Z) and water as an aerosol raw material composition and carbon dioxide as a compressed gas, had a flame length of 0 cm at both water concentrations of 1.0% by mass and 5.0% by mass. Further, although not shown in Table 9, when aerosol compositions containing 1233zd(E) and water as an aerosol raw material composition and nitrogen as a compressed gas were prepared and the flame length was measured in the same manner as the aerosol compositions shown in Table 9, the flame length was 4 cm or more at both water concentrations of 1.0% by mass and 5.0% by mass.

(Evaluation of Foam Condition of Aerosol Product)

An aqueous component A not containing 1224yd(Z) was prepared in accordance with the formulation shown in Table 10. An aerosol raw material composition was prepared by mixing 1224yd(Z) and the aqueous component A such that the concentration of the aqueous component A was 80.0% by mass with respect to a total amount of the aqueous component A and 1224yd(Z), and the thus obtained aerosol raw material composition was filled into a tin spray container. Subsequently, as a compressed gas, a carbon dioxide or nitrogen was filled into the body of the spray container, and the pressure inside the container was adjusted to be MPa (25° C.), whereby an aerosol product was produced.

TABLE 10

| Aqueous component A | % by mass |
|---|---|
| Purified water | 65.4 |
| Myristic acid | 4.6 |
| (LUNAC MY-98 (trade name), manufactured | |
| by Kao Corporation | |
| Stearic acid | 2.4 |
| (purified stearic acid 550V (trade name), | |
| manufactured by Kao Corporation | |
| Methylparaben | 0.1 |
| POE(2) cetyl ether | 1.0 |
| (NIKKOL BC-2 (trade name), manufactured | |
| by Nikko Chemicals Co., Ltd. | |
| Sorbitol | 5.0 |
| (SORBITOL KAO (trade name), manufactured | |
| by Kao Corporation | |
| Triethanolamine 20%-by-mass aqueous solution | 21.5 |
| Total | 100.0 |

Using the thus produced aerosol product, the foam condition and the low-temperature discharge condition of the aerosol composition discharged from the aerosol product were evaluated by the following evaluation methods.

The foam condition was evaluated as follows. The aerosol product was immersed for at least 30 minutes in a thermostat water bath controlled at 25° C. ±0.5° C. to adjust the aerosol composition in the aerosol product to have a constant temperature. Thereafter, 1 g of a foam of the aerosol composition was discharged on the palm, and the condition of the discharged foam was evaluated based on the following criteria.

(Evaluation Criteria of Foam Condition)
AA: A hemispherical and cold foam having a fine texture was formed.
A: A hemispherical and slightly cold foam having a fine texture was formed.

The low-temperature discharge condition was evaluated as follows. The aerosol product was stored for 3 days in a refrigerator at 5° C.±0.5° C. to adjust the aerosol composition in the aerosol product to have a constant temperature. Thereafter, the discharge condition of a foam of the aerosol composition was evaluated based on the following criteria.

(Evaluation Criteria of Low-Temperature Discharge Condition)
AA: The aerosol composition was smoothly discharged, and a hemispherical to mound-like foam was formed.
A: The aerosol composition was slightly smoothly discharged, and a hemispherical to mound-like foam was formed.

TABLE 11

| Aerosol composition | | | | | |
|---|---|---|---|---|---|
| 1224yd(Z) + aqueous component | | | | | Low- |
| | Aqueous | | | Foam | temperature |
| 1224yd(Z) | component | Total | Compressed | condi- | discharge |
| % by | % by | % by | gas | tion | condition |
| weight | weight | weight | — | — | — |
| 20 | 80 | 100 | nitrogen | A | AA |
| 20 | 80 | 100 | carbon | AA | A |
| | | | dioxide | | |

As shown in Table 11, the aerosol products in which a composition containing 1224yd(Z) and water was filled yielded a steric and cold foam having a fine texture. The aerosol product using nitrogen as a compressed gas exhibited a particularly excellent low-temperature discharge condition. Meanwhile, the aerosol product using carbon dioxide had a tendency that discharge thereof was slightly difficult at the low temperature as compared to the aerosol product using nitrogen; however, the resulting foam had a beautiful hemispherical and mound-like shape. Based on these results, according to one embodiment of the invention, an aerosol raw material composition, an aerosol composition, and an aerosol product, which yield a beautiful foam condition when discharged from a container such as a spray can, can be provided.

The disclosure of Japanese Patent Application No. 2021-039454 filed on Mar. 11, 2021, is hereby incorporated by reference in its entirety. All the documents, patent applications, and technical standards that are described in the present specification are hereby incorporated by reference to the same extent as if each individual document, patent application, or technical standard is concretely and individually described to be incorporated by reference.

1. An aerosol raw material composition, comprising:
water; and
1-chloro-2,3,3,3-tetrafluoropropene,
wherein a content of water is 1.0% by mass or more with respect to a total amount of water and 1-chloro-2,3,3,3-tetrafluoropropene.

2. The aerosol raw material composition according to claim 1, wherein a content of water is 5.0% by mass or more with respect to the total amount of water and 1-chloro-2,3,3,3-tetrafluoropropene.

3. The aerosol raw material composition according to claim 1, wherein the total amount of water and 1-chloro-2,3,3,3-tetrafluoropropene is 50.0% by mass or more with respect to a total amount of the aerosol raw material composition.

4. The aerosol raw material composition according to claim 1, wherein a sprayed content in a flame generation condition test has a flame length of less than 4.0 cm, the flame generation condition test comprising:
as a spray container, one which includes a container body, a valve mechanism having a stem orifice diameter of 0.45 mm, a discharge member having a discharge orifice diameter of 0.6 mm, and a spray tube having an inner diameter of 1.0 mm is used; an aerosol product is prepared by filling an aerosol composition formed of the aerosol raw material composition and nitrogen into the spray container such that a pressure inside the spray container is 0.6 MPa at 25° C.; using the thus prepared aerosol product as a sample, a flame generation condition test is conducted in accordance with the procedure prescribed in JIS S3301(2018) 6.5, except that a spray nozzle of the sample is positioned 5 cm away from a flame burner; and a difference between a horizontal length of a flame with spraying of the content of the sample and the horizontal length of a flame without the spraying is defined as the flame length of the sprayed content.

5. The aerosol raw material composition according to claim 3, wherein a sprayed content in a flame generation condition test has a flame length of less than 4.0 cm, the flame generation condition test comprising:
as a spray container, one which includes a container body, a valve mechanism having a stem orifice diameter of 0.45 mm, a discharge member having a discharge orifice diameter of 0.6 mm, and a spray tube having an inner diameter of 1.0 mm is used; an aerosol product is prepared by filling an aerosol composition formed of the aerosol raw material composition and nitrogen into the spray container such that a pressure inside the spray container is 0.6 MPa at 25° C.; using the thus prepared aerosol product as a sample, a flame generation condition test is conducted in accordance with the procedure prescribed in JIS S3301(2018) 6.5, except that a spray nozzle of the sample is positioned 5 cm away from a flame burner; and a difference between a horizontal length of a flame with spraying of the content of the sample and the horizontal length of a flame without the spraying is defined as the flame length of the sprayed content.

6. The aerosol raw material composition according to claim 1, further comprising a surfactant.

7. The aerosol raw material composition according to claim 1, further comprising an alcohol.

8. An aerosol composition, comprising:
the aerosol raw material composition according to claim 1; and
at least one of a compressed gas or a liquefied gas.

9. The aerosol composition according to claim 8, comprising, as the compressed gas, at least one selected from the group consisting of nitrogen, air, oxygen, hydrogen, carbon dioxide, and nitrous oxide.

10. The aerosol composition according to claim 8, comprising, as the compressed gas, at least one selected from the group consisting of nitrogen and carbon dioxide.

11. The aerosol composition according to claim 8, comprising, as the liquefied gas, at least one selected from the group consisting of a liquefied petroleum gas, dimethyl ether, and a hydrofluoroolefin.

12. The aerosol composition according to claim 8, wherein a sprayed content in a flame generation condition test has a flame length of less than 4.0 cm, the flame generation condition test comprising:
as a spray container, one which includes a container body, a valve mechanism having a stem orifice diameter of 0.45 mm, a discharge member having a discharge orifice diameter of 0.6 mm, and a spray tube having an inner diameter of 1.0 mm is used; an aerosol product is prepared by filling the aerosol composition into the spray container such that a pressure inside the spray container is 0.6MPa at 25° C.; using the thus prepared aerosol product as a sample, a flame generation condition test is conducted in accordance with the procedure prescribed in JIS S3301(2018) 6.5, except that a spray nozzle of the sample is positioned 5 cm away from a flame burner; and a difference between a horizontal length of a flame with spraying of the content of the sample and the horizontal length of a flame without the spraying is defined as the flame length of the sprayed content.

13. An aerosol product, comprising:
a container body; and
the aerosol composition according to claim 8, which is stored inside the container body.

14. The aerosol product according to claim 13, further comprising a valve mechanism attached to the container body.

15. The aerosol product according to claim 13, wherein a pressure inside the container body is 0.2 MPa or higher at 25° C.

16. The aerosol product according to claim 13, wherein a sprayed content in a flame generation condition test has a flame length of less than 4.0 cm, the flame generation condition test comprising:
using the aerosol product as a sample, a flame generation condition test is conducted in accordance with the procedure prescribed in JIS S3301(2018) 6.5, except that a spray nozzle of the sample is positioned 5 cm away from a flame burner; and a difference between a horizontal length of a flame with spraying of the content of the sample and the horizontal length of a flame without the spraying is defined as the flame length of the sprayed content.
